(19) United States
(12) Patent Application Publication
(10) Pub. No.: US 2024/0372703 A1
(43) Pub. Date: Nov. 7, 2024

(54) INFORMATION PROCESSING APPARATUS, INFORMATION PROCESSING METHOD, AND PROGRAM

(71) Applicant: Sony Group Corporation, Tokyo (JP)

(72) Inventors: Taizo SHIRAI, Kanagawa (JP); Yoshiya ASAUMI, Tokyo (JP); Shinya MARUYAMA, Kanagawa (JP); Masatomo KURATA, Tokyo (JP)

(73) Assignee: Sony Group Corporation, Tokyo (JP)

(21) Appl. No.: 18/689,082

(22) PCT Filed: Mar. 10, 2022
(86) PCT No.: PCT/JP2022/010481

§ 371 Date: Mar. 5, 2024

(30) Foreign Application Priority Data
Sep. 16, 2021 (JP) 2021-151229

(51) Int. Cl. H04L 9/08; H04L 9/00; H04L 9/14; H04L 9/32

(52) U.S. Cl. CPC H04L 9/0825; H04L 9/14; H04L 9/3247; H04L 9/3263; H04L 9/50

(57) ABSTRACT

There is provided an information processing apparatus, an information processing method, and a program capable of improving user convenience. An information generation unit generates association information in which a plurality of public keys is associated, and a recording control unit records the association information in a blockchain. The present technology can be applied to, for example, an information processing system using a blockchain.

### TECHNICAL FIELD

The present technology relates to an information processing apparatus, an information processing method, and a program, and particularly relates to, for example, an information processing apparatus, an information processing method, and a program capable of improving convenience of a user.

### BACKGROUND ART

For example, in a service using a blockchain, a digital signature is generated using a secret key (key for signature generation) of a wallet, and the digital signature is verified using a public key (key for verification) for the secret key.

The wallet is software or hardware (object) that functions as a storage (means) of a secret key, and includes a hot wallet and a cold wallet.

The hot wallet is, for example, a wallet connected to a communication environment such as the Internet, and the cold wallet is a wallet that is not (cannot be) connected to the communication environment.

Examples of the hot wallet include a mobile wallet stored in a mobile terminal such as a smartphone, a wallet stored in a personal computer (PC), a server, or the like. Examples of the cold wallet include a hardware wallet (HWW) capable of universal serial bus (USB) connection and the like, a paper wallet in which a secret key is described on paper, and the like.

Note that Patent Document 1 describes a technology of a smart card that stores a secret key used in a case where generation of a (digital) signature using a secret key and verification of the signature using a public key are used for verification of authenticity of a message, and an operator ID (identification) corresponding to an individual.

### CITATION LIST

### Patent Document

Patent Document 1: US Patent Application Publication No. 2019/0286805 A

### SUMMARY OF THE INVENTION

### Problems to be Solved by the Invention

For example, in a case where the user owns a plurality of wallets, if the same processing, for example, processing of transaction data such as remittance of cryptocurrency from the same address (account) can be performed when using a certain wallet and when using another wallet, the user does not need to distinguish a plurality of wallets, and convenience of the user can be improved.

The present technology has been made in view of such a situation, and is intended to improve user convenience.

### Solutions to Problems

An information processing apparatus or a program according to the present technology is an information processing apparatus including: an information generation unit that generates association information in which a plurality of public keys is associated; and a recording control unit that records the association information in a blockchain, or a program for causing a computer to function as such an information processing apparatus.

An information processing method of the present technology is an information processing method including: generating association information in which a plurality of public keys is associated; and recording the association information in a blockchain.

In the information processing apparatus, the information processing method, and the program of the present technology, association information in which a plurality of public keys is associated is generated and recorded in the blockchain.

The information processing apparatus may be an independent device or may be an internal block which forms one device.

The program can be provided by transmitting via a transmission medium or by recording on a recording medium.

### BRIEF DESCRIPTION OF DRAWINGS

FIG. 1 is a diagram illustrating a configuration example of one embodiment of an information processing system to which the present technology is applied.

FIG. 2 is a diagram for explaining an example of first processing of an information processing system 10.

FIG. 3 is a data flow diagram illustrating a flow of data in first processing.

FIG. 4 is a diagram illustrating a configuration example of hardware of a computer as a front-end server 11, a management server 16, a node 21, a smartphone 31, and a PC 32.

FIG. 5 is a diagram for explaining an example of second processing of the information processing system 10.

FIG. 6 is a diagram for explaining an example of second processing of the information processing system 10.

FIG. 7 is a data flow diagram illustrating a flow of data in second processing.

FIG. 8 is a block diagram illustrating a functional configuration example of a management server 16 that generates association information in which a plurality of public keys is associated and records the association information in a blockchain in second processing.

FIG. 9 is a diagram for explaining an example of third processing of the information processing system 10.

FIG. 10 is a data flow diagram illustrating a flow of data in third processing.

FIG. 11 is a diagram for explaining an example of fourth processing of the information processing system 10.

FIG. 12 is a data flow diagram illustrating a flow of data in fourth processing.

FIG. 13 is a block diagram illustrating a functional configuration example of a smartphone 31 that generates association information in which a public key PK_{X1} of a hot wallet and a public key PK_{X2} of an HWW 41 as a plurality of public keys are associated with each other and records the association information in a blockchain in fourth processing.

FIG. 14 is a diagram for explaining an example of fifth processing of the information processing system 10.

FIG. 15 is a data flow diagram illustrating a flow of data in fifth processing.

FIG. 16 is a block diagram illustrating a functional configuration example of a smartphone 31 that generates invalidation information RI and records the invalidation information RI in a blockchain in fifth processing.

FIG. 17 is a diagram for explaining an example of sixth processing of the information processing system 10.

FIG. 18 is a data flow diagram illustrating a flow of data in sixth processing.

FIG. 19 is a block diagram illustrating a functional configuration example of a front-end server 11 that generates invalidation information RI and records the invalidation information RI in a blockchain in sixth processing.

FIG. 20 is a diagram for explaining an example of seventh processing of the information processing system 10.

FIG. 21 is a data flow diagram illustrating a flow of data in seventh processing.

FIG. 22 is a block diagram illustrating a functional configuration example of a smartphone 31 that performs processing corresponding to multi-signature in seventh processing.

### MODE FOR CARRYING OUT THE INVENTION

<One Embodiment of Information Processing System to which Present Technology is Applied>

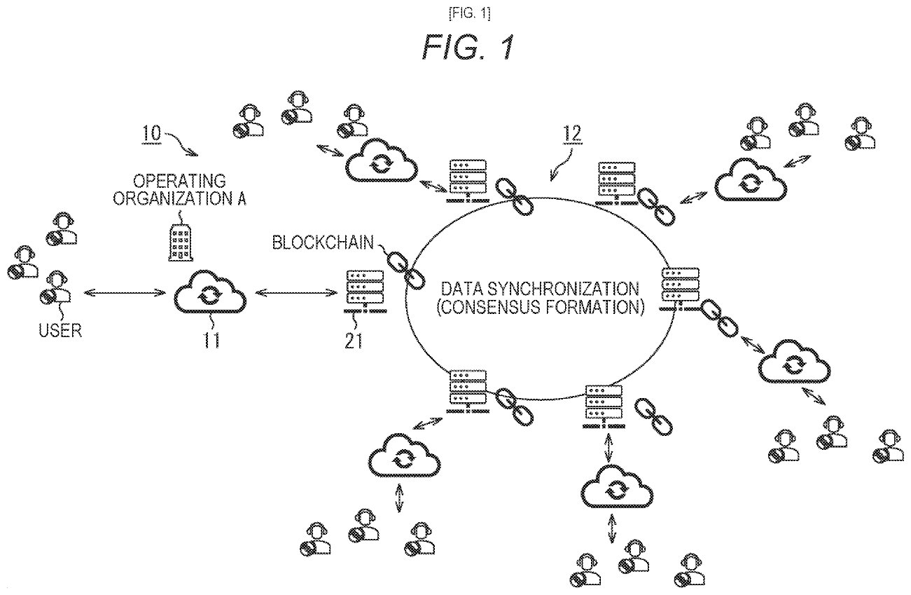

FIG. 1 is a diagram illustrating a configuration example of one embodiment of an information processing system to which the present technology is applied.

In FIG. 1, an information processing system 10 is an information processing system using a blockchain, and includes one or more front-end servers 11, a blockchain system 12, and the like. The information processing system 10 records information (transaction data) from the user in a blockchain as a distributed ledger (database).

As a recording destination (data structure) in which information is recorded, other than the blockchain, for example, a specific server or the like can be adopted.

However, by recording the information in the blockchain, it is possible to refer to the information from an arbitrary operating organization that provides a service to the user, manage the blockchain as a database common to a plurality of operating organizations, eliminate a single point of failure, and the like.

The front-end server 11 is managed by an operating organization A that provides services, receives access from a user, and executes various processes.

For example, the front-end server 11 requests (node 21 of) the blockchain system 12 to record transaction data in the blockchain in response to a request from a user who is a member of a service provided by the operating organization A. As a result, for example, in a case where the operating organization A provides a service for managing digital content, the user can record information regarding digital content such as music created by the user, information regarding transfer of the digital content, and the like in the blockchain.

The blockchain system 12 is, for example, a consortium-type blockchain system managed by the operating organization A, and includes a plurality of nodes 21.

The node 21 is a server (computer) that executes a computer program for confirming the validity and authenticity of data to be recorded in the blockchain, and recording the data for which the validity and authenticity have been confirmed in the blockchain.

Validity of data means that the data meets a predetermined criterion. In the confirmation of the validity of the data, for example, it is confirmed whether the size of the data and other formats conform to a predetermined format, whether the time stamp is appropriate, whether the address of the beneficiary exists, and the like.

The authenticity of the data means that the data has not been altered. In the data authenticity confirmation, the digital signature added to the data is verified.

A plurality of nodes 21 of the blockchain system 12 constitutes a peer-to-peer (P2P) network and holds a blockchain as a distributed ledger (database).

For example, in response to a request for recording transaction data from the front-end server 11, the node 21 confirms the validity and authenticity of the transaction data and generates a block including the transaction data. Then, when a consensus is formed according to a predetermined consensus algorithm for the block, the node 21 adds (records) the block to the blockchain. In each node 21, the block in which the consensus is formed is added to the blockchain, so that data synchronization of the blockchain is achieved.

Note that, as the blockchain system 12, other types of blockchain systems such as a public blockchain, for example, can be adopted in addition to the consortium-type blockchain system.

Furthermore, the front-end server 11 can refer to (the transaction data recorded in) the blockchain held by the node 21 in response to a request or the like from the user. In the front-end server 11, it is possible to speed up access from the front-end server 11 to the blockchain by holding a copy of the blockchain held by the node 21.

### <First Processing of Information Processing System 10>

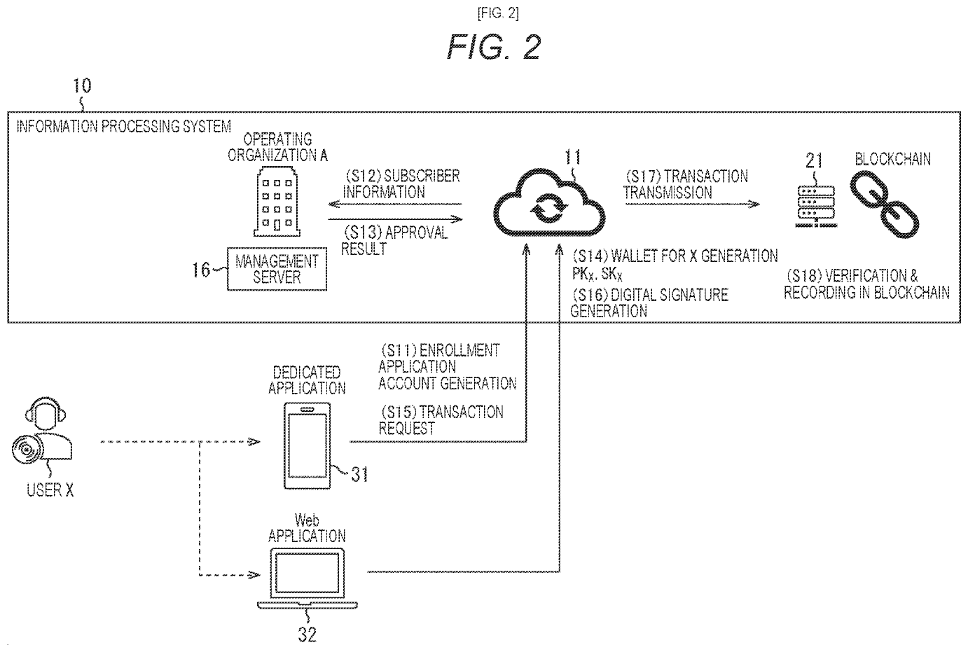

FIG. 2 is a diagram for explaining an example of first processing of the information processing system 10 in FIG. 1.

In order to receive the provision of the service a provided by the operating organization A, the user X who intends to become a member of the service a installs the dedicated application provided by the operating organization A on, for example, a smartphone 31 as a mobile terminal possessed by the user X.

The user X activates the dedicated application and operates the smartphone 31 so as to request application for enrollment in the service a and generation of an account.

In step S11, the smartphone 31 (dedicated application thereof) transmits an enrollment request to the front-end server 11 (via a network such as the Internet (not illustrated)) in response to the operation of the user X.

The enrollment request is a request for enrollment application and account generation, and includes subscriber information. The subscriber information is information regarding the user X who applies for enrollment, for example, the name, password, e-mail address, credit card number for charging for the provision of the service a, and the like of the user X. The subscriber information is input by the user X operating the smartphone 31.

The front-end server 11 receives the enrollment request from the smartphone 31, and transmits the subscriber information included in the enrollment request to a management server 16 managed by the operating organization A (via the network) in step S12.

The management server 16 receives the subscriber information from the front-end server 11, and determines whether to approve the enrollment of the user X using the subscriber information.

In step S13, the management server 16 transmits an approval result, which is a determination result on whether to approve the enrollment of the user X, to the front-end server 11 (via the network).

The front-end server 11 receives the approval result from the management server 16, and performs processing for enrollment or rejection of enrollment according to the approval result.

That is, in a case where the approval result indicates that the enrollment of the user X is not approved, the front-end server 11 performs processing for rejecting the enrollment.

For example, the front-end server 11 transmits a rejection message indicating rejection of the enrollment to the smartphone 31 that has transmitted the enrollment request (via the network).

In this case, the smartphone 31 receives and displays the rejection message. With the display of the rejection message, the user X can recognize that the enrollment is rejected.

On the other hand, in a case where the approval result indicates that the enrollment of the user X is approved, the front-end server 11 performs a process for the enrollment.

For example, the front-end server 11 generates a user ID as an account of the user X and transmits the user ID to the smartphone 31 that has transmitted the enrollment request.

In this case, the smartphone 31 receives and displays the user ID. By displaying the user ID, the user X can recognize the user ID as the account of the service a.

In the process for enrollment, the front-end server 11 further generates a hot wallet associated with the user ID of the user X in step S14 (secures a storage area as a hot wallet). Then, the front-end server 11 generates the secret key SK_{X} and the public key PK_{X} corresponding to the secret key SK_{X}, and keeps (stores) the secret key SK_{X} and the public key PK_{X} in the hot wallet associated with the user ID of the user X. In the hot wallet, the secret key SK_{X} is securely kept.

Thereafter, in a case of receiving the provision of the service a, the user X operates the smartphone 31 and inputs the user ID and the password to log in to the service a.

That is, the smartphone 31 transmits the user ID and the password to the front-end server 11, and the front-end server 11 performs authentication using the user ID and the password from the smartphone 31. When the authentication is successful, the front-end server 11 provides the service a to the smartphone 31. As a result, the smartphone 31 can receive the provision of the service a.

For example, the user X can input transaction information regarding a transaction provided as the service a by operating the smartphone 31.

For example, in a case where the service a is a service related to digital content, it is possible to input transaction information requesting that the authorship of the digital content created by the user X be proved to be the user X or transferred to another user.

In step S15, the smartphone 31 transmits a transaction request for requesting a transaction corresponding to the transaction information to the front-end server 11 in response to the operation of the user X. The transaction request includes transaction information.

The front-end server 11 receives a transaction request from the smartphone 31 and generates transaction data corresponding to transaction information included in the transaction request.

Then, in step S16, the front-end server 11 generates a digital signature of the transaction data and generates the digitally signed transaction data.

The digital signature of the transaction data can be generated by generating a hash value of the transaction data and performing signature generation processing on the hash value with the secret key SK_{X} of the hot wallet associated with the user ID of the user X. As the signature generation processing with the secret key, for example, encryption with the secret key can be adopted.

In step S17, the front-end server 11 transmits the digitally signed transaction data to the node 21 (via the network) and requests recording of the transaction data in the blockchain.

The node 21 receives the digitally signed transaction data from the front-end server 11. In step S18, the node 21 performs verification and the like of the digital signature of the digitally signed transaction data (confirms the validity and authenticity of the transaction data), and when the verification and the like are successful, records the transaction data in the blockchain.

In the node 21, the digital signature is verified using the public key PK_{X} for the secret key SK_{X} of the hot wallet associated with the user ID of the user X. For example, the front-end server 11 transmits a public key certificate of the public key PK_{X} to the node 21, and the node 21 may obtain the public key PK_{X} from the public key certificate.

Note that the user X can receive the provision of the service a using a PC 32 in addition to the smartphone 31. In a case where the PC 32 is used, a web application described in, for example, html, JavaScript (registered trademark), or the like for providing the service a is provided from the front-end server 11 to the PC 32. In the PC 32, by executing the web application on the web browser, processing similar to that of the smartphone 31 that executes the dedicated application is performed. Hereinafter, it is assumed that the user X uses the smartphone 31, and the description of a case where the PC 32 is used is omitted.

Furthermore, in FIG. 2, the hot wallet stored in the front-end server 11 is adopted as the wallet, but as the wallet, for example, a mobile wallet stored in the smartphone 31 of the user X can be adopted.

Furthermore, in FIG. 2, the management server 16 determines whether to approve the enrollment of the user X, but the determination of the approval of the enrollment can be performed by the front-end server 11 instead of the management server 16. In this case, it is not necessary to perform communication between the front-end server 11 and the management server 16.

Further, the front-end server 11 can also serve as the management server 16. In a case where the front-end server 11 also serves as the management server 16, the management server 16 does not need to be provided.

Further, in FIG. 2, the hot wallet is stored in the front-end server 11, but the hot wallet can be stored in the smartphone 31 instead of the front-end server 11. That is, the hot wallet may be stored in either the front-end server 11 or the smartphone 31. One of the front-end server 11 and the smartphone 31 that stores the hot wallet is in charge of processing using the secret key of the hot wallet.

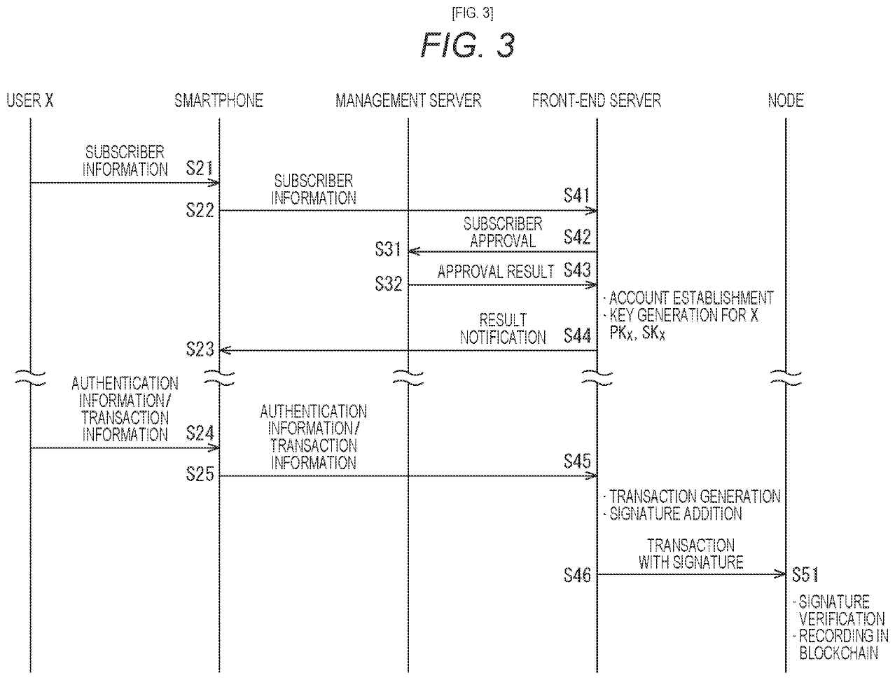

FIG. 3 is a data flow diagram illustrating a flow of data in the first processing.

When the user X operates the smartphone 31 so as to input the subscriber information of the user X, the smartphone 31 receives (acquires) the subscriber information according to the operation of the user X in step S21.

In step S22, the smartphone 31 transmits an enrollment request including the subscriber information to the front-end server 11.

In step S41, the front-end server 11 receives an enrollment request including subscriber information from the smartphone 31.

In step S42, the front-end server 11 transmits an inquiry about approval of the enrollment of the user X corresponding to the subscriber information to the management server 16 together with the subscriber information included in the enrollment request from the smartphone 31.

In step S31, the management server 16 receives the subscriber information from the front-end server 11. Then, the management server 16 determines whether or not the enrollment of the user X is approved using the subscriber information.

In step S32, the management server 16 transmits an approval result, which is a determination result as to whether to approve the enrollment of the user X, to the front-end server 11.

In step S43, the front-end server 11 receives the approval result from the management server 16.

For example, in a case where the approval result indicates that the enrollment of the user X is approved, the front-end server 11 generates the user ID as the account of the user X (establishes the account).

Further, the front-end server 11 generates a hot wallet associated with the user ID of the user X, a secret key SK_{X} kept in the hot wallet, and a public key PK_{X} corresponding to the secret key SK_{X}. The front-end server 11 keeps the secret key SK_{X} and the public key PK_{X} in a hot wallet.

In step S44, the front-end server 11 transmits (provides notification of) the approval result to the smartphone 31 together with the user ID.

In step S23, the smartphone 31 receives and displays the approval result and the user ID from the front-end server 11.

Thereafter, in a case of receiving the provision of the service a, the user X operates the smartphone 31 so as to input the user ID and the password as the authentication information and the transaction information.

In step S24, the smartphone 31 receives the authentication information and the transaction information according to the operation of the user X.

In step S25, the smartphone 31 transmits a transaction request including the authentication information and the transaction information to the front-end server 11.

In step S45, the front-end server 11 receives the authentication information and the transaction request from the smartphone 31.

The front-end server 11 authenticates the user X using the authentication information, and when the authentication is successful, generates transaction data corresponding to the transaction information included in the transaction request.

Then, the front-end server 11 generates a digital signature of the transaction data using the secret key SK_{X} of the hot wallet associated with the user ID of the user X and generates the digitally signed transaction data.

In step 546, the front-end server 11 transmits the digitally signed transaction data to the node 21.

In step 551, the node 21 receives the digitally signed transaction data from the front-end server 11.

Then, the node 21 verifies the digital signature of the digitally signed transaction data, and records the transaction data in the blockchain when the verification or the like is successful.

### <Configuration Example of Hardware of Computer as Front-End Server 11, Management Server 16, Node 21, Smartphone 31, and PC 32>

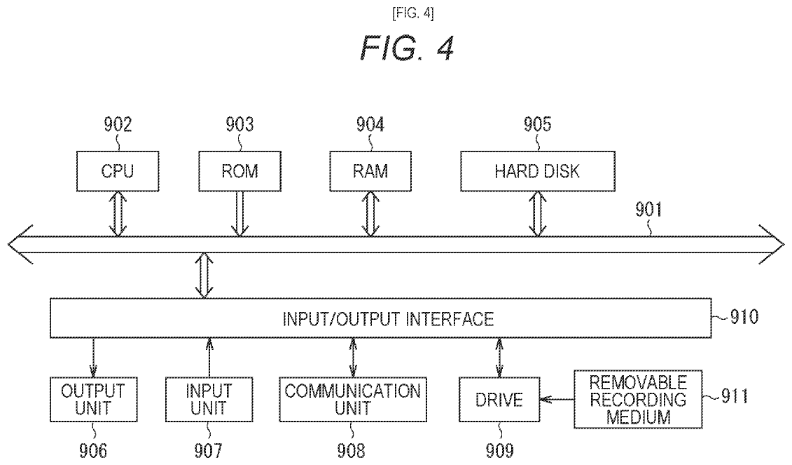

FIG. 4 is a diagram illustrating a configuration example of hardware of a computer as the front-end server 11, the management server 16, the node 21, the smartphone 31, and the PC 32.

The program executed by the computer can be recorded in advance in a hard disk 905 or a ROM 903 as a recording medium built in the computer.

Alternatively, the program can be stored (recorded) in a removable recording medium 911 driven by a drive 909. Such a removable recording medium 911 can be provided as so-called package software. Here, examples of the removable recording medium 911 include, for example, a flexible disk, a compact disc read only memory (CD-ROM), a magneto optical (MO) disk, a digital versatile disc (DVD), a magnetic disk, a semiconductor memory, and the like.

Note that the program can be installed in the computer from the removable recording medium 911 as described above, or can be downloaded to the computer via a communication network or a broadcasting network and installed in the built-in hard disk 905. In other words, for example, the program can be wirelessly transferred from a download site to the computer via an artificial satellite for digital satellite broadcasting, or can be transferred by a wire to the computer via a network such as a local area network (LAN) and the Internet.

The computer has a built-in central processing unit (CPU) 902, and an input/output interface 910 is connected to the CPU 902 via a bus 901.

When a command is inputted by a user operating an input unit 907 or the like via the input/output interface 910, in response to this, the CPU 902 executes a program stored in the read only memory (ROM) 903. Alternatively, the CPU 902 loads the program stored in the hard disk 905 into a random access memory (RAM) 904 and executes the program.

As a result, the CPU 902 performs various processes described in the present specification. Then, the CPU 902 outputs a processing result thereof from an output unit 906 or transmits the processing result from a communication unit 908 if necessary via the input/output interface 910 for example, and further causes recording of the processing result on the hard disk 905, or the like.

Note that the input unit 907 includes a keyboard, a mouse, a microphone, and the like, and receives an input from the user. Furthermore, the output unit 906 includes a liquid crystal display (LCD), a speaker, and the like, and displays (outputs) an image, outputs sound, and the like.

Here, the performance (capacity, processing speed, and the like) of each block constituting the computer may be different depending on the front-end server 11, the management server 16, the node 21, the smartphone 31, and the PC 32.

### <Second Processing of Information Processing System 10>

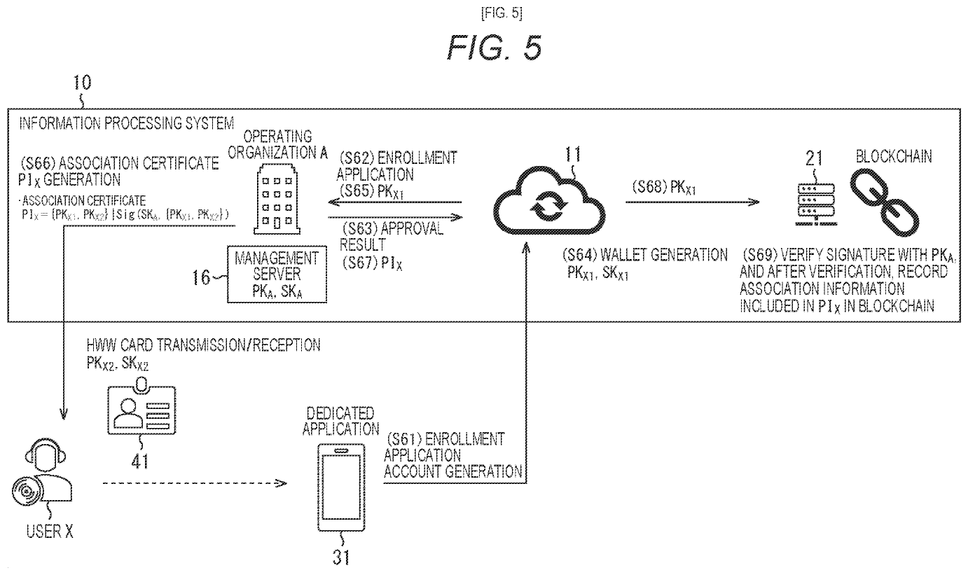

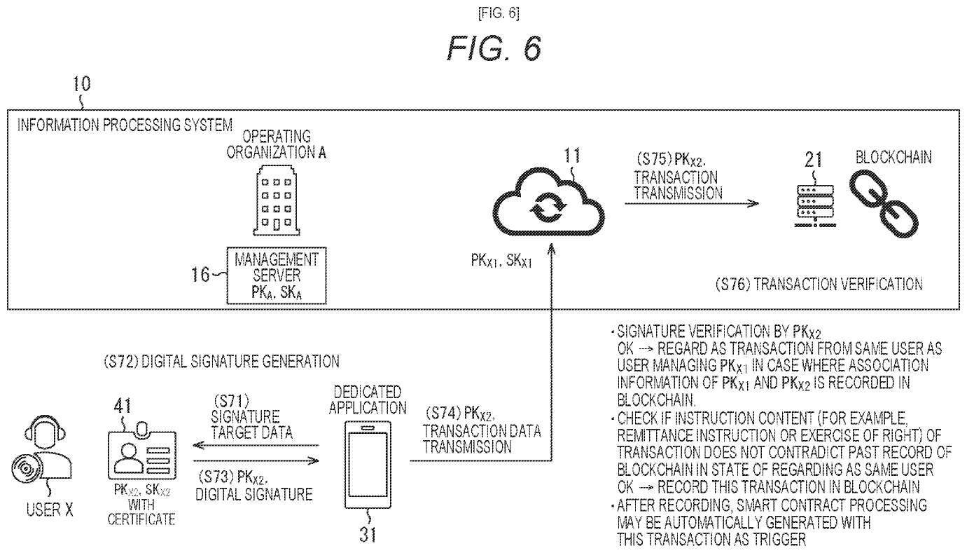

FIGS. 5 and 6 are diagrams for explaining an example of second processing of the information processing system 10 in FIG. 1.

In the operating organization A, a membership card system that issues a membership card on which information regarding a user such as a face photograph is printed to a user who intends to become a member of the service a may be introduced.

In the membership card system, for example, HWW (hereinafter, also referred to as a membership card type HWW) that also serves as a membership card can be introduced.

In a case where the membership card type HWW is introduced, when the user X applies for enrollment in the service a, a hot wallet is issued (generated) and the membership card type HWW is issued (sent) to the user.

In a case where the user X receives the provision of the service a, either a hot wallet or a membership card type HWW can be used.

However, the secret key of the hot wallet (the secret key kept in the hot wallet) and the secret key of the membership card type HWW (the secret key kept in the membership card type HWW) are different. Therefore, the user X is treated as different users in the blockchain system 12 between the case of using the hot wallet and the case of using the membership card type HWW.

Therefore, the user needs to distinguish between the case of using the hot wallet and the case of using the membership card type HWW, and management of the wallet (here, a hot wallet and a membership card type HWW) is a heavy burden for the user.

In this manner, the burden of managing the wallet on the user can be an obstacle to the introduction of the membership card type HWW.

Therefore, in the present technology, association information in which a plurality of public keys such as a public key (for a secret key) of a hot wallet and a public key (for a secret key) of a membership card type HWW is associated with each other is generated. The association information is information indicating that a plurality of public keys associated in the association information is owned by the same user.

According to the association information, the owners of the plurality of public keys associated in the association information, for example, the public key of the hot wallet and the public key of the membership card type HWW are treated as the same user, whereby the convenience of the user can be improved.

That is, the user can use the hot wallet and the membership card type HWW without distinction, and the user can easily manage the wallet.

In addition, coexistence of the hot wallet and the membership card type HWW (the secret key and the public key thereof) is facilitated.

The second processing of the information processing system 10 in FIGS. 5 and 6 is processing performed in a case where the membership card system is introduced as described above.

FIG. 5 illustrates processing performed at the time of application for enrollment in the service a in the second processing.

Similarly to the case of the first processing, the user X activates the dedicated application installed in the smartphone 31, and operates the smartphone 31 so as to request the enrollment application in the service a and the generation of the account.

In step S61, the smartphone 31 transmits an enrollment request including the subscriber information to the front-end server 11 according to the operation of the user X.

The front-end server 11 receives the enrollment request from the smartphone 31, and transmits the subscriber information included in the enrollment request to the management server 16 managed by the operating organization A in step S62, thereby applying for enrollment of the user X in the service a.

The management server 16 receives the subscriber information from the front-end server 11, and determines whether to approve the enrollment of the user X using the subscriber information.

In step S63, the management server 16 transmits an approval result, which is a determination result as to whether to approve the enrollment of the user X, to the front-end server 11.

The front-end server 11 receives the approval result from the management server 16, and performs processing for enrollment or rejection of enrollment according to the approval result.

In the processing for rejecting the enrollment, processing similar to the case of the first processing is performed.

In the process for enrollment, similarly to the case of the first processing, the user ID is generated and transmitted to the smartphone 31.

Further, in step S64, the front-end server 11 generates a hot wallet (first wallet) associated with the user ID of the user X. Then, the front-end server 11 generates the secret key SK_{X1} and the public key PK_{X1} corresponding to the secret key SK_{X1}, and keeps the secret key SK_{X1} and the public key PK_{X1} in the hot wallet associated with the user ID of the user X.

In step S65, the front-end server 11 transmits the public key PK_{X1} of the hot wallet to the management server 16.

In a case where the management server 16 obtains an approval result indicating that the enrollment of the user X is approved, in the operating organization A, the HWW 41 (second wallet) for the user X is produced, and sent to and received by the user X.

The HWW 41 is, for example, a card type membership card type HWW in which information regarding the user X is printed.

The HWW 41 has a function of securely keeping a secret key SK_{X2} (different from the secret key SK_{X1} of the hot wallet) and keeping a public key PK_{X2} for the secret key SK_{X2}.

Further, the HWW 41 has a function of performing wireless or wired communication with the smartphone 31 (and the PC 32). Then, the HWW 41 has a function of receiving (accepting) data transmitted from the outside such as the smartphone 31, generating a digital signature of the data using the secret key SK_{X2}, and transmitting (outputting) the digital signature to the outside.

In step S66, the management server 16 generates the association certificate PI_{X} that certifies the authenticity of the association information in which the public key PK_{X1} (first public key) of the hot wallet associated with the user ID of the user X and the public key PK_{X2} (second public key) of the HWW 41 for the user X are associated with each other.

That is, the management server 16 generates association information {PK_{X1}, PK_{X2}} in which the public key PK_{X}, from the front-end server 11 is associated with the public key PK_{X2} of the HWW 41. Note that a user ID can be associated with the association information.

The management server 16 stores a secret key SK_{A} of the operating organization A and a public key PK_{A} for the secret key SK_{A}.

The management server 16 generates a digital signature Sig (SK_{A}, {PK_{X1}, PK_{X2}}) of the association information {PK_{X1}, PK_{X2}} using the secret key SK_{A}. Sig (A, B) indicates that a signature for data (information) B is generated with the key A.

Then, the management server 16 adds the digital signature Sig (SK_{A}, {PK_{X1}, PK_{X2}}) to the association information {PK_{X1}, PK_{X2}} to generate an association certificate PI_{X}={PK_{X1}, PK_{X2}}|Sig (SK_{A}, {PK_{X1}, PK_{X2}}) certifying authenticity of the association information. A|B represents that A is followed by B.

Note that the association certificate PI_{X} may include a field of additional information such as a date and a user ID.

In the second processing, as described above, the management server 16 generates association information in which the public key PK_{X1} of the hot wallet generated according to the application from the user X is associated with the public key PK_{X2} of the HWW 41 sent (provided) to the user X according to the application from the user X.

Then, the management server 16 generates a digital signature Sig (SK_{A}, {PK_{X1}, PK_{X2}}) of the association information using the secret key SK_{A} of the operating organization A, and generates an association certificate PI_{X}={PK_{X1}, PK_{X2}}|Sig (SK_{A}, {PK_{X1}, PK_{X2}}) including the digital signature Sig (SK_{A}, {PK_{X1}, PK_{X2}}).

In step 567, the management server 16 performs recording control to record the association information {PK_{X1}, PK_{X2}} included in the association certificate PI_{X} in the blockchain by transmitting the association certificate PI_{X} to the blockchain system 12.

That is, the management server 16 transmits the association certificate PI_{X} to the front-end server, and requests the front-end server 11 to record the association information in the blockchain.

The front-end server 11 receives the association certificate PI_{X} from the management server 16, transmits the association certificate PI_{X} to the node 21 in step S68, and requests recording of the association information in the blockchain.

The node 21 receives the association certificate PI_{X} from the front-end server 11. In step S69, the node 21 performs the verification of the digital signature Sig (SK_{A}, {PK_{X1}, PK_{X2}}) included in the association certificate PI_{X} or the like, and when the verification or the like is successful, records the association information {PK_{X1}, PK_{X2}} included in the association certificate PI_{X} in the blockchain.

The digital signature Sig (SK_{A}, {PK_{X1}, PK_{X2}}) is verified using the public key PK_{A} for the secret key SK_{A} of the operating organization A. The public key PK_{A} can be acquired from a public key certificate including the public key PK_{A}, similarly to the case of verifying the digital signature of the digitally signed transaction data described in FIG. 2.

Hereinafter, description of acquisition of the public key used for verification of the digital signature will be appropriately omitted.

Note that the association certificate PI_{X} can include the user ID of the user X. In the blockchain, the association information {PK_{X1}, PK_{X2}} can be recorded in association with the user ID.

FIG. 6 illustrates processing performed in a case where the user X receives provision of the service a after applying for enrollment in the service a in the second processing.

In the blockchain system 12 (FIG. 1), in a case where the association information is recorded in the blockchain, transaction data is processed assuming that owners of a plurality of associated public keys in the association information including a public key (hereinafter, also referred to as a verification public key) used to verify a digital signature of the transaction data are the same user.

For example, in a case where the association information {PK_{X1}, PK_{X2}} is recorded in the blockchain, if the public key used to verify the digital signature is one of the public keys PK_{X1} and PK_{X2} associated in the association information {PK_{X1}, PK_{X2}}, the transaction data is processed assuming that the owners of the public keys PK_{X1} and PK_{X2} are the same user.

Therefore, the user X can use the hot wallet stored in the front-end server 11 in association with the user ID of the user X and the HWW 41 that is the membership card type HWW without particular distinction.

In a case of receiving the provision of the service a, the user X logs in to the service a similarly to the case of the first processing.

For example, in a case where the user X receives provision of the service a using the HWW 41 out of the hot wallet and the HWW 41, the user X connects the HWW 41 to the smartphone 31, or the like, to bring the smartphone 31 and the HWW 41 into a communicable state.

Then, for example, similarly to the case of the first processing, the user X inputs the transaction information by operating the smartphone 31.

In step S71, the smartphone 31 generates transaction data corresponding to the transaction information input according to the operation of the user X. The smartphone 31 generates a hash value of the transaction data and transmits the hash value to the HWW 41 as signature target data used for generating a digital signature.

The HWW 41 receives the signature target data from the smartphone 31, and generates a digital signature of the transaction data using the signature target data in step S72.

In the HWW 41, the digital signature of the transaction data can be generated by performing signature generation processing on signature target data (hash value of the transaction data) with the secret key SK_{X2} kept in the HWW 41.

The HWW 41 transmits the digital signature of the transaction data and the public key PK_{X2} kept in the HWW 41, that is, (the public key certificate of) the public key PK_{X2} for the secret key SK_{X2} to the smartphone 31.

The smartphone 31 receives the digital signature and the public key PK_{X2} from the HWW 41 and adds the digital signature to the transaction data to generate digitally signed transaction data.

In step S74, the smartphone 31 requests a transaction by transmitting the digitally signed transaction data and the public key PK_{X2} to the front-end server 11.

The front-end server 11 receives the digitally signed transaction data and the public key PK_{X2} from the smartphone 31.

In step S75, the front-end server 11 transmits the digitally signed transaction data and the public key PK_{X2} to the node 21, and requests recording of the transaction data in the blockchain.

The node 21 receives the digitally signed transaction data and the public key PK_{X2} from the front-end server 11. In step S76, the node 21 performs transaction verification on the digitally signed transaction data.

In the transaction verification, the node 21 verifies the digital signature of the digitally signed transaction data from the front-end server 11 using the public key PK_{X2} also from the front-end server 11.

Furthermore, the node 21 confirms validity of the transaction data as transaction verification.

When the verification of the digital signature succeeds and the validity of the transaction data is confirmed, the node 21 determines whether the association information including the public key PK_{X2} which is the verification public key used for verifying the digital signature is recorded in the blockchain as the transaction verification.

In a case where the association information including the public key PK_{X2} from the front-end server 11 is recorded in the blockchain, the node 21 regards owners of a plurality of associated public keys in the association information including the public key PK_{X2} as the same user, and processes the transaction data.

For example, in a case where the association information {PK_{X1}, PK_{X2}} is recorded in the blockchain, the node 21 processes the transaction data assuming that the owner (user) of the public key PK_{X2} used to verify the digital signature from the front-end server 11 is the owner of a specific public key among a plurality of public keys associated in the association information {PK_{X1}, PK_{X2}}, for example, the first public key PK_{X1}.

For example, in a case where the transaction data is information giving an instruction on remittance or transfer of digital content, and the address specifying the remittance person or the transferrer is generated using the public key, the owner of the public key PK_{X2} used for verification of the digital signature is regarded as the owner of the specific public key PK_{X1} among the plurality of public keys PK_{X1} and PK_{X2} associated in the association information {PK_{X1}, PK_{X2}}, and the address is generated using the specific public key PK_{X1} instead of the public key PK_{X2} used for verification of the digital signature.

As the transaction verification, the node 21 confirms that the instruction content such as remittance or transfer of digital content, for example, indicated by the transaction data does not contradict the past record of the blockchain in a state where the owners of the associated public keys in the association information including the public key PK_{X2} are regarded as the same user.

When it is confirmed that the instruction content represented by the transaction data does not contradict the past record of the blockchain, the node 21 records the transaction data in the blockchain.

A smart contract may be executed when transaction data is recorded in a blockchain as a trigger.

On the other hand, in a case where the association information including the public key PK_{X2} used for verifying the digital signature is not recorded in the blockchain, the node 21 processes the transaction data similarly to the case of FIG. 2.

Note that, in FIG. 6, a case where the user X receives the provision of the service a using the HWW 41 among the hot wallet and the HWW 41 has been described, but the user X can also receive the provision of the service a using the hot wallet.

In a case where the user X uses the hot wallet, the digital signature of the transaction data is verified as described in FIG. 2, but the verification is performed by using the public key PK_{X1} of the hot wallet.

Then, in a case where the association information including the public key PK_{X1} used for verifying the digital signature is recorded in the blockchain, the node 21 considers that the owners of the associated public keys in the association information including the public key PK_{X1} are the same user, and processes the transaction data.

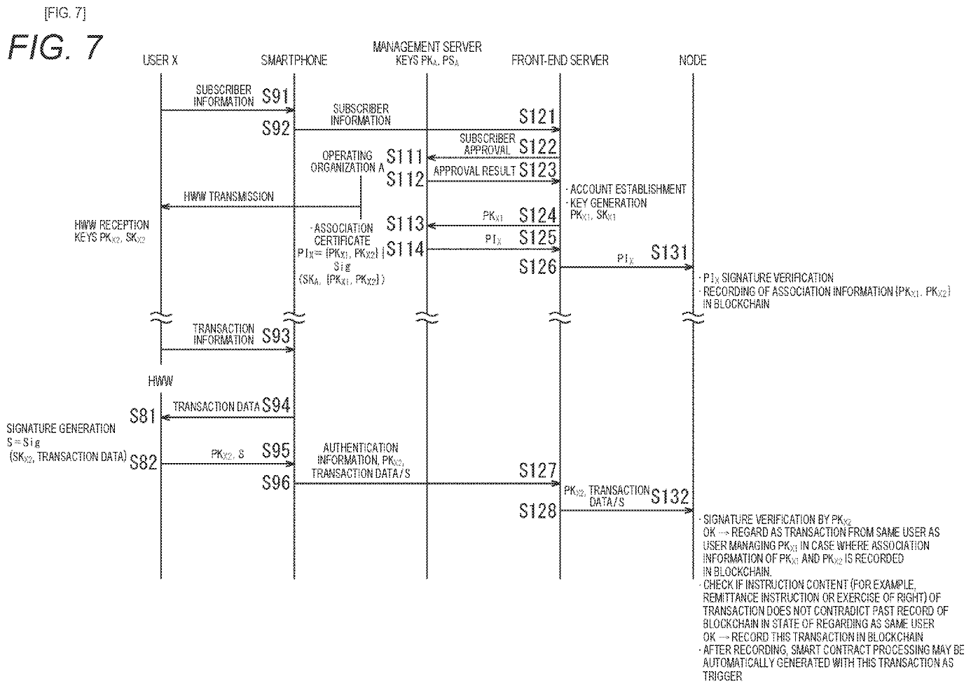

FIG. 7 is a data flow diagram illustrating a flow of data in the second processing.

When the user X operates the smartphone 31 so as to input the subscriber information of the user X, the smartphone 31 receives the subscriber information according to the operation of the user in step S91.

In step S92, the smartphone 31 transmits an enrollment request including the subscriber information to the front-end server 11.

In step S121, the front-end server 11 receives an enrollment request including subscriber information from the smartphone 31.

In step S122, the front-end server 11 transmits an inquiry about approval of the enrollment of the user X corresponding to the subscriber information to the management server 16 together with the subscriber information included in the enrollment request from the smartphone 31.

In step S111, the management server 16 receives the subscriber information from the front-end server 11. Then, the management server 16 determines whether or not the enrollment of the user X is approved using the subscriber information.

In step S112, the management server 16 transmits an approval result, which is a determination result as to whether to approve the enrollment of the user X, to the front-end server 11.

In the management server 16, for example, in a case where an approval result indicating that the enrollment of the user X is approved is obtained, in the operating organization A, the HWW 41 as the membership card type HWW for the user X is produced and sent to the user X. The user X receives the HWW 41.

In step S123, the front-end server 11 receives the approval result from the management server 16.

For example, in a case where the approval result indicates that the enrollment of the user X is approved, the front-end server 11 generates the user ID as the account of the user X (establishes the account).

Further, the front-end server 11 generates a hot wallet associated with the user ID of the user X, a secret key SK_{X} kept in the hot wallet, and a public key PK_{X} corresponding to the secret key SK_{X}. The front-end server 11 keeps the secret key SK_{X} and the public key PK_{X} in a hot wallet.

Then, the approval result is transmitted to the smartphone 31 together with the user ID by the front-end server 11, and the approval result and the user ID from the front-end server 11 are received and displayed in the smartphone 31.

In step S124, the front-end server 11 transmits the public key PK_{X1} of the hot wallet associated with the user ID of the user X to the management server 16.

In step S113, the management server 16 receives the public key PK_{X1} of the hot wallet from the front-end server 11.

The management server 16 generates association information {PK_{X1}, PK_{X2}} in which the public key PK_{X1} from the front-end server 11 is associated with the public key PK_{X2} of the HWW 41.

The management server 16 generates a digital signature Sig (SK_{A}, {PK_{X1}, PK_{X2}}) of the association information {PK_{X1}, PK_{X2}} using the secret key SK_{A} of the operating organization A.

Then, the management server 16 generates the association certificate PI_{X}={PK_{X1}, PK_{X2}}|Sig (SK_{A}, {PK_{X1}, PK_{X2}}) by adding the digital signature Sig (SK_{A}, {PK_{X1}, PK_{X2}}) to the association information {PK_{X1}, PK_{X2}}.

In step S114, the management server 16 transmits the association certificate PI_{X} to the front-end server, and requests the front-end server 11 to record the association information in the blockchain.

In step S125, the front-end server 11 receives the association certificate PI_{X} from the management server 16, and in step S126, transmits the association certificate PI_{X} to the node 21 to request recording of the association information in the blockchain.

In step S131, the node 21 receives the association certificate PI_{X} from the front-end server 11. The node 21 performs the verification of the digital signature Sig (SK_{A}, {PK_{X1}, PK_{X2}}) included in the association certificate PI_{X} or the like, and when the verification or the like is successful, records the association information {PK_{X1}, PK_{X2}} included in the association certificate PI_{X} in the blockchain.

Thereafter, in a case of receiving the provision of the service a by using the HWW 41, the user X operates the smartphone 31 to use the HWW 41, and further, the user X operates the smartphone 31 to input transaction information.

In step S93, the smartphone 31 receives the transaction information according to the operation of the user.

The smartphone 31 generates transaction data corresponding to transaction information input according to the operation of the user X.

In step S94, the smartphone 31 transmits the hash value of the transaction data as signature target data to the HWW 41.

In step S81, the HWW 41 receives the hash value of the transaction data from the smartphone 31.

The HWW 41 generates a digital signature S=Sig (SK_{X2}, hash value of transaction data) of transaction data from the smartphone 31 using the secret key SK_{X2} kept in the HWW 41.

In step S82, the HWW 41 transmits the digital signature S of the transaction data and the public key PK_{X2} kept in the HWW 41 to the smartphone 31.

In step S95, the smartphone 31 receives the digital signature S and the public key PK_{X2} from the HWW 41.

The smartphone 31 generates transaction data with the digital signature S by adding the digital signature S to the transaction data.

In step S96, the smartphone 31 transmits the authentication information, the transaction data with the digital signature S, and the public key PK_{X2} to the front-end server 11.

In step S127, the front-end server 11 receives the authentication information from the smartphone 31, the transaction data with the digital signature S, and the public key PK_{X2}.

The front-end server 11 authenticates the user X using the authentication information, and when the authentication is successful, transmits the transaction data with the digital signature S and the public key PK_{X2} to the node 21 in step S128.

In step S132, the node 21 receives the transaction data with the digital signature S and the public key PK_{X2} from the front-end server 11.

The node 21 performs transaction verification on the transaction data with the digital signature S and processes the transaction data as described in FIG. 6.

Therefore, in a case where the association information including the public key PK_{X2} used for verifying the digital signature S of the transaction data with the digital signature S is recorded in the blockchain, in the node 21, the transaction data is processed assuming that the owners of the associated public keys in the association information including the public key PK_{X2} are the same user.

Note that, in a case where the association information including the public key PK_{X2} used for verifying the digital signature S is not recorded in the blockchain, transaction data is processed similarly to the case of FIG. 2.

Here, the association information can be recorded in a means other than the blockchain, for example, can be recorded in a table as a recording area for the association information secured in (the recording medium of) the front-end server 11.

In this case, the association information can be confirmed by accessing the table of the front-end server 11 without accessing the blockchain.

Furthermore, in the association information, in addition to the two public keys PK_{X1} and PK_{X2}, three or more public keys can be associated. For example, public keys (for secret keys) of three or more wallets issued to the same user may be associated.

The type of wallet in which (the secret keys for) the plurality of public keys to be associated in the association information is kept is not particularly limited.

For example, it is possible to associate a public key of a hot wallet with a public key of a cold wallet such as an HWW, associate public keys of a plurality of hot wallets, or associate public keys of a plurality of cold wallets.

Furthermore, as the public key associated in the association information, in addition to the public key of the wallet, an arbitrary public key (verification public key) used for verification of the digital signature can be adopted. For example, in a case where the public keys PK1 and PK2 used for verifying the digital signature are associated in the association information, the digital signature generated using the secret key for the public key PK1 and the digital signature generated using the secret key for the public key PK2 can be treated as digital signatures of the same user.

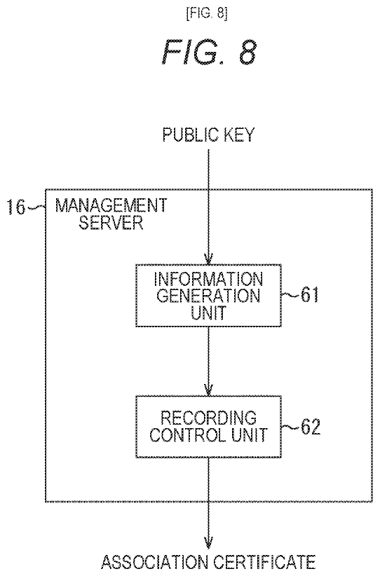

FIG. 8 is a block diagram illustrating a functional configuration example of the management server 16 that generates association information in which a plurality of public keys is associated and records the association information in the blockchain in the second processing.

The management server 16 includes an information generation unit 61 and a recording control unit 62.

The information generation unit 61 acquires a plurality of public keys to be associated in the association information.

For example, the information generation unit 61 receives and acquires the public key PK_{X1} of the hot wallet transmitted from the front-end server 11. In addition, the information generation unit 61 acquires the public key PK_{X2} of the HWW 41 by communicating with the HWW 41 before being sent to the user X by the operating organization A.

The information generation unit 61 associates a plurality of acquired public keys, for example, the public key PK_{X1} of the hot wallet with the public key PK_{X2} of the HWW 41, and generates association information.

The information generation unit 61 generates a digital signature of the association information by using the secret key SK_{A} of the operating organization A.

Further, the information generation unit 61 adds a digital signature of the association information to the association information to generate an association certificate, and supplies the association certificate to the recording control unit 62.

The recording control unit 62 performs recording control to record the association information in the blockchain.

The recording control unit 62 transmits the association certificate from the information generation unit 61 to (the node 21 of) the blockchain system 12 via the front-end server 11, thereby recording the association information included in the association certificate in the blockchain.

### <Third Processing of Information Processing System 10>

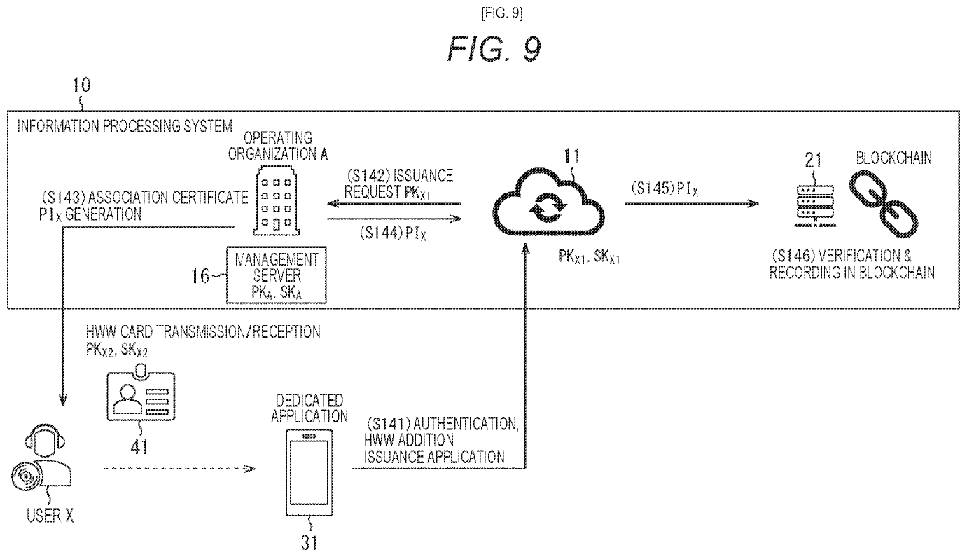

FIG. 9 is a diagram for explaining an example of third processing of the information processing system 10 in FIG. 1.

For a new user who applies for enrollment in the service a after the introduction of the membership card system, a hot wallet and the HWW 41 as a membership card type HWW can be simultaneously issued as described in the second processing.

On the other hand, when the membership card system is introduced, a user who has already been a member of the service a, that is, a user who already owns a hot wallet may wish to issue the HWW 41 as the membership card type HWW.

The third processing of the information processing system 10 of FIG. 9 is processing performed in a case where the user who owns the hot wallet desires to issue the HWW 41 as described above.

FIG. 9 illustrates processing performed at the time of application for enrollment in the service a in the third processing.

Note that, in the third processing, it is assumed that the user X is already a member of the service a and owns the hot wallet.

The user X activates the dedicated application installed in the smartphone 31, and operates the smartphone 31 to log in to the service a and apply for (addition) issuance of the HWW.

In step S141, the smartphone 31 logs in to the service a by transmitting the authentication information to the front-end server 11 according to the operation of the user X.

Further, in step S141, the smartphone 31 transmits an HWW issuance application request to the front-end server 11 according to the operation of the user X.

The front-end server 11 receives an HWW issuance application request from the smartphone 31. In step S142, the front-end server 11 transmits the public key PK_{X1} of the hot wallet associated with the user ID of the user X and the issuance request for requesting issuance of the HWW to the management server 16 managed by the operating organization A.

The management server 16 receives the public key PK_{X1} and the issuance request from the front-end server 11, and determines whether to approve issuance of the HWW in response to the issuance request.

For example, in a case where the public key PK_{X1} from the front-end server 11 satisfies a predetermined condition such as being kept in a hot wallet stored in the front-end server 11, the management server 16 determines to approve issuance of the HWW.

In a case where the issuance of the HWW is approved in the management server 16, in the operating organization A, the HWW 41 for the user X who owns the hot wallet keeping the public key PK_{X1} from the front-end server 11 is produced, and sent to and received by the user X.

Further, in step S143, similarly to the case of the second processing, the management server 16 generates an association certificate PI_{X}={PK_{X1}, PK_{X2}}|Sig (SK_{A}, {PK_{X1}, PK_{X2}}) for certifying authenticity of association information in which the public key PK_{X1} of the hot wallet associated with the user ID of the user X and the public key PK_{X2} of the HWW 41 for the user X are associated with each other.

In the third processing, as described above, the management server 16 generates association information in which the public key PK_{X1} of the hot wallet already owned by the user X is associated with the public key PK_{X2} of the HWW 41 sent (provided) to the user X in response to the application from the user X.

Then, similarly to the case of the second processing, the management server 16 generates a digital signature Sig (SK_{A}, {PK_{X1}, PK_{X2}}) of the association information by using the secret key SK_{A} of the operating organization A, and generates an association certificate PI_{X}={PK_{X1}, PK_{X2}} | Sig (SK_{A}, {PK_{X1}, PK_{X2}}) including the digital signature Sig (SK_{A}, {PK_{X1}, PK_{X2}}).

In step S144, the management server 16 performs recording control to record the association information {PK_{X1}, PK_{X2}} included in the association certificate PI_{X} in the blockchain by transmitting the association certificate PI_{X} to the blockchain system 12.

That is, the management server 16 transmits an approval result that is a determination result indicating approval of issuance of the HWW and the association certificate PI_{X} to the front-end server 11, and requests recording of the association information in the blockchain.

The front-end server 11 receives the approval result and the association certificate PI_{X} from the management server 16, transmits the association certificate PI_{X} to the node 21 in step S145, and requests recording of the association information in the blockchain.

The node 21 receives the association certificate PI_{X} from the front-end server 11. In step S146, the node 21 verifies the digital signature Sig (SK_{A}, {PK_{X1}, PK_{X2}}) included in the association certificate PI_{X}, and the like, similarly to the case of the second processing. Then, when the verification and the like are successful, the node 21 records the association information {PK_{X1}, PK_{X2}} included in the association certificate PI_{X} in the blockchain.

As described above, after the association information is recorded in the blockchain, the user can receive the provision of the service a as the same user by using either the hot wallet or the HWW 41 similarly to the case of the second processing.

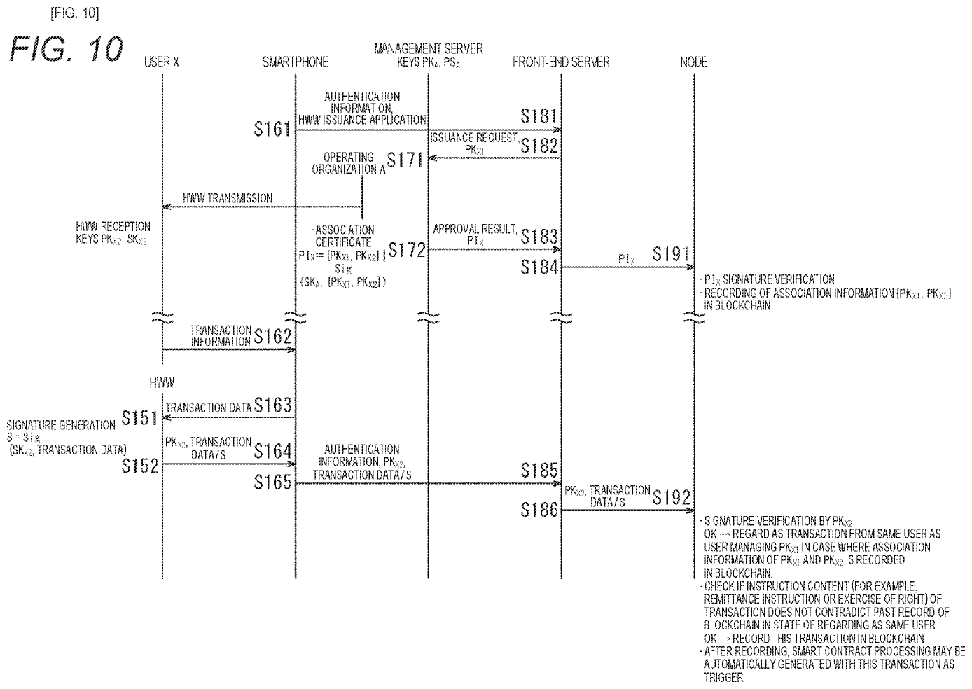

FIG. 10 is a data flow diagram illustrating a flow of data in the third processing.

In step S161, the smartphone 31 transmits the authentication information and the HWW issuance application request to the front-end server 11 according to the operation of the user X.

In step S181, the front-end server 11 receives the authentication information and the HWW issuance application request from the smartphone 31.

The front-end server 11 permits login to the service a of the smartphone 31 according to the authentication information from the smartphone 31.

Then, in step S182, the front-end server 11 transmits the public key PK_{X1} of the hot wallet associated with the user ID of the user X and the HWW issuance request to the management server 16 managed by the operating organization A.

In step S171, the management server 16 receives the public key PK_{X1} and the issuance request from the front-end server 11.

The management server 16 determines whether to approve the issuance of the HWW in response to the issuance request from the front-end server 11.

In a case where it is determined in the management server 16 that the issuance of the HWW is approved, in the operating organization A, the HWW 41 for the user X who owns the hot wallet keeping the public key PK_{X1} from the front-end server 11 is produced and sent to the user X. The user X receives the HWW 41.

In addition, the management server 16 generates association information {PK_{X1}, PK_{X2}} in which the public key PK_{X1} from the front-end server 11 is associated with the public key PK_{X2} of the HWW 41.

The management server 16 generates a digital signature Sig (SK_{A}, {PK_{X1}, PK_{X2}}) of the association information {PK_{X1}, PK_{X2}} using the secret key SK_{A} of the operating organization A.

Then, the management server 16 generates the association certificate PI_{X}={PK_{X1}, PK_{X2}}|Sig (SK_{A}, {PK_{X1}, PK_{X2}}) by adding the digital signature Sig (SK_{A}, {PK_{X1}, PK_{X2}}) to the association information {PK_{X1}, PK_{X2}}.

In step S172, the management server 16 transmits an approval result indicating that the issuance of the HWW is approved and the association certificate PI_{X} to the front-end server 11, and requests the front-end server 11 to record the association information in the blockchain.

In step S183, the front-end server 11 receives the approval result from the management server 16 and the association certificate PI_{X}. In step S184, the front-end server 11 transmits the association certificate PI_{X} to the node 21 and requests the node 21 to record the association information in the blockchain.

In step S191, the node 21 receives the association certificate PI_{X} from the front-end server 11. The node 21 performs the verification of the digital signature Sig (SK_{A}, {PK_{X1}, PK_{X2}}) included in the association certificate PI_{X} or the like, and when the verification or the like is successful, records the association information {PK_{X1}, PK_{X2}} included in the association certificate PI_{X} in the blockchain.

As described above, after the association information is recorded in the blockchain, the user can receive the provision of the service a as the same user by using either the hot wallet or the HWW 41 similarly to the case of the second processing.

For example, in a case where the user X receives provision of the service a using the HWW 41, processing similar to that in the case of FIG. 7 is performed.

That is, in steps S151 and S152, steps S162 to S165, steps S185 and S186, and step S192, processes similar to those in steps S81 and S82, steps S93 to S96, steps S127 and S128, and step S132 in FIG. 7 are performed.

Note that, in the third processing, the functional configuration example of the management server 16 that generates the association information in which a plurality of public keys is associated and records the association information in the blockchain is similar to the case of the second processing illustrated in FIG. 8.

### <Fourth Processing of Information Processing System 10>

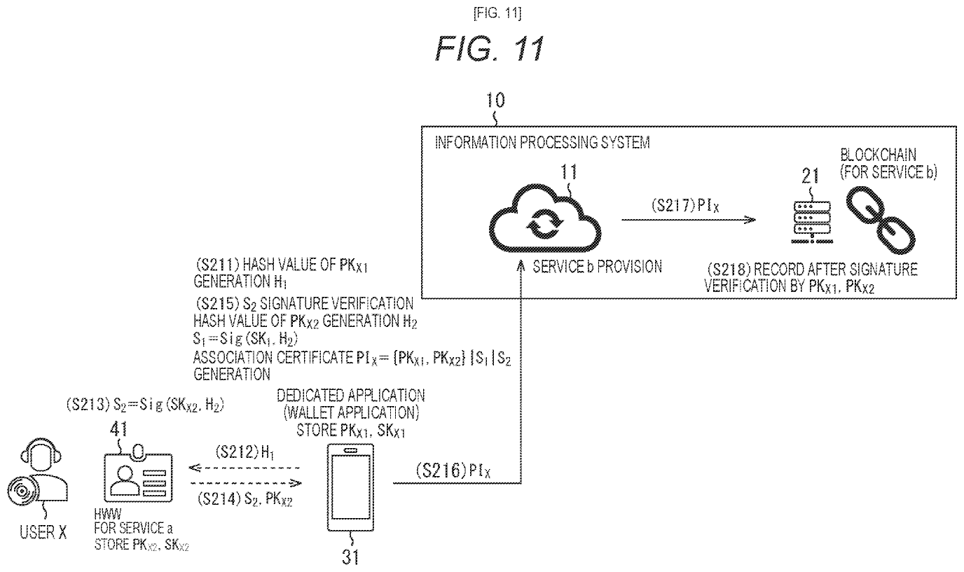

FIG. 11 is a diagram for explaining an example of fourth processing of the information processing system 10 in FIG. 1.

For example, in a case where the operating organization A provides another service b together with the service a, or another operating organization provides the service b, and the user X is a member of both the services a and b, if the HWW 41 (for the service a) issued to receive the provision of the service a can be used also when receiving the provision of another service b, the convenience of the user can be improved.

Here, as described above, enabling the HWW 41 issued to receive the provision of the service a to be used also when receiving the provision of another service b can be referred to as transferring (a part of) the authority to receive the provision of the service b to the HWW 41.

The fourth processing of the information processing system 10 of FIG. 11 is a process of transferring the authority to receive the provision of the service b to the HWW 41 as described above.

Note that, in the fourth processing, it is assumed that the user X has already become a member of the services a and b. Then, it is assumed that the user X already owns the HWW 41 for the service a and the hot wallet (for the service b) issued to receive the provision of the service b.

In addition, in the fourth processing, it is assumed that a wallet application for receiving the provision of the service b is installed as a dedicated application in the smartphone 31. Then, it is assumed that the hot wallet is stored (managed) in the wallet application (smartphone 31).

In a case where the authority to receive the provision of the service b is transferred to the HWW 41, the user X activates the wallet application as a dedicated application installed in the smartphone 31. Then, the user X operates the smartphone 31 so as to transfer the authority to receive the provision of the service b to the HWW 41.

In step S211, the smartphone 31 generates the hash value H₁ of the public key PK_{X1} of the hot wallet according to the operation of the user X.

In step S212, the smartphone 31 transmits the hash value H₁ of the public key PK_{X1} of the hot wallet to the HWW 41. Here, it is assumed that the smartphone 31 and the HWW 41 are in a communicable state.

The HWW 41 receives the hash value H₁ of the public key PK_{X1} of the hot wallet from the smartphone 31.

In step S213, the HWW 41 generates a digital signature S₂=Sig (SK_{X2}, H₁) (second digital signature) of the public key PK_{X1} by performing signature generation processing on the hash value H₁ of the public key PK_{X1} (first public key) of the hot wallet with the secret key (secret key kept in the HWW 41) SK_{X2} (second secret key) of the HWW 41.

In step S214, the HWW 41 transmits the digital signature S₂ of the public key PK_{X1} and the public key (public key kept in the HWW 41) PK_{X2} of the HWW 41 to the smartphone 31.

The smartphone 31 receives the digital signature S₂ of the public key PK_{X1} and the public key PK_{X2} of the HWW 41 from the HWW 41.

In step S215, the smartphone 31 verifies the digital signature S₂ of the public key PK_{X1} using the public key PK_{X2} of the HWW 41. When the verification of the digital signature S₂ is successful, the smartphone 31 generates the hash value H₂ of the public key PK_{X2} of the HWW 41.

Further, the smartphone 31 generates the digital signature S₁ (first digital signature) of the public key PK_{X2} by performing signature generation processing on the hash value H₂ of the public key PK_{X2} (second public key) of the HWW 41 with the secret key SK_{X1} (first secret key) of the hot wallet.

Then, the smartphone 31 generates the association certificate PI_{X} that certifies the authenticity of the association information in which the public key PK_{X1} (first public key) of the hot wallet is associated with the public key PK_{X2} (second public key) of the HWW 41.

That is, the smartphone 31 generates association information {PK_{X1}, PK_{X2}} in which the public key PK_{X1} of the hot wallet and the public key PK_{X2} of the HWW 41 are associated with each other. Note that a user ID for the user X to receive the provision of the service b can be associated with the association information.

The smartphone 31 adds the digital signature S₁ of the public key PK_{X2} and the digital signature S₂=Sig (SK_{X2}, H₁) of the public key PK_{X1} to the association information {PK_{X1}, PK_{X2}} to generate an association certificate PI_{X}={PK_{X1}, PK_{X2}}|S₁|S₂ that certifies the authenticity of the association information.

Note that the association certificate PI_{X} may include a field of additional information such as a date and a user ID.

In the fourth processing, as described above, the smartphone 31 generates association information in which the public key PK_{X1} of the hot wallet already owned by the user X and the public key PK_{X2} of the HWW 41 already owned by the user X are associated with each other.

Then, the smartphone 31 adds the digital signature S₁ obtained by performing the signature generation processing on (the hash value H₂ of) the public key PK_{X2} of the HWW 41 with the secret key SK_{X1} of the hot wallet and the digital signature S₂ obtained by performing the signature generation processing on (the hash value H₁ of) the public key PK_{X1} of the hot wallet with the secret key SK_{X2} of the HWW 41 to the association information {PK_{X1}, PK_{X2}}, thereby generating the association certificate PI_{X}={PK_{X1}, PK_{X2}}|S₁|S₂ including the digital signatures S₁ and S₂.

In step S216, the smartphone 31 transmits the association certificate PI_{X} to the blockchain system 12, thereby performing recording control to record the association information {PK_{X1}, PK_{X2}} included in the association certificate PI_{X} in the blockchain.

That is, the smartphone 31 transmits the association certificate PI_{X} to the front-end server 11 that provides the service b (for the service b), and requests recording of the association information in the blockchain.

The front-end server 11 receives the association certificate PI_{X} from the smartphone 31, transmits the association certificate PI_{X} to the node 21 in step S217, and requests the node 21 to record the association information in the blockchain.

The node 21 receives the association certificate PI_{X} from the front-end server 11. In step S218, the node 21 performs verification of the digital signatures S₁ and S₂ included in the association certificate PI_{X} or the like, and when the verification or the like is successful, records the association information {PK_{X1}, PK_{X2}} included in the association certificate PI_{X} in the blockchain (for the service b).

In the verification of the digital signature S₁, the node 21 decrypts the digital signature S₁ with the public key PK_{X1} (returns the digital signature to the original state), obtains the hash value of the public key PK_{X2} of the association information {PK_{X1}, PK_{X2}} included in the association certificate PI_{X}, and checks whether or not the decryption result of the digital signature S₁ matches the hash value of the public key PK_{X2}.

In the verification of the digital signature S₂, the node 21 decrypts the digital signature S₂ with the public key PK_{X2}, obtains the hash value of the public key PK_{X1} of the association information {PK_{X1}, PK_{X2}} included in the association certificate PI_{X}, and checks whether or not the decryption result of the digital signature S₂ matches the hash value of the public key PK_{X1}.

As described above, after the association information {PK_{X1}, PK_{X2}} is recorded in the blockchain, the user X can receive the provision of the service b by using the HWW 41 for the service a similarly to the case of the second processing and the third processing.

Note that, in FIG. 11, it is assumed that the smartphone 31 stores a hot wallet for the service b. However, the hot wallet for the service b may be stored not by the smartphone 31 but by the front-end server 11 that provides the service b (for the service b), for example, similarly to the case of the second processing and the third processing.

In a case where the front-end server 11 for service b stores a hot wallet for service b, the front-end server 11 for service b communicates with the smartphone 31 to exchange necessary information with the HWW 41, and performs processing similar to that of the smartphone 31 in a case where the hot wallet for service b is stored.

That is, the front-end server 11 for the service b performs the processing of steps S211, S212, and S215 instead of the smartphone 31.

In this case, it is desirable to prevent unauthorized access to the HWW 41 via the smartphone 31 by performing authentication between the front-end server 11 for the service b and the smartphone 31, or the like.

Furthermore, the front-end server 11 for the service b can also serve as a front-end server for the service a. That is, the front-end server 11 can provide both the service a and the service b.

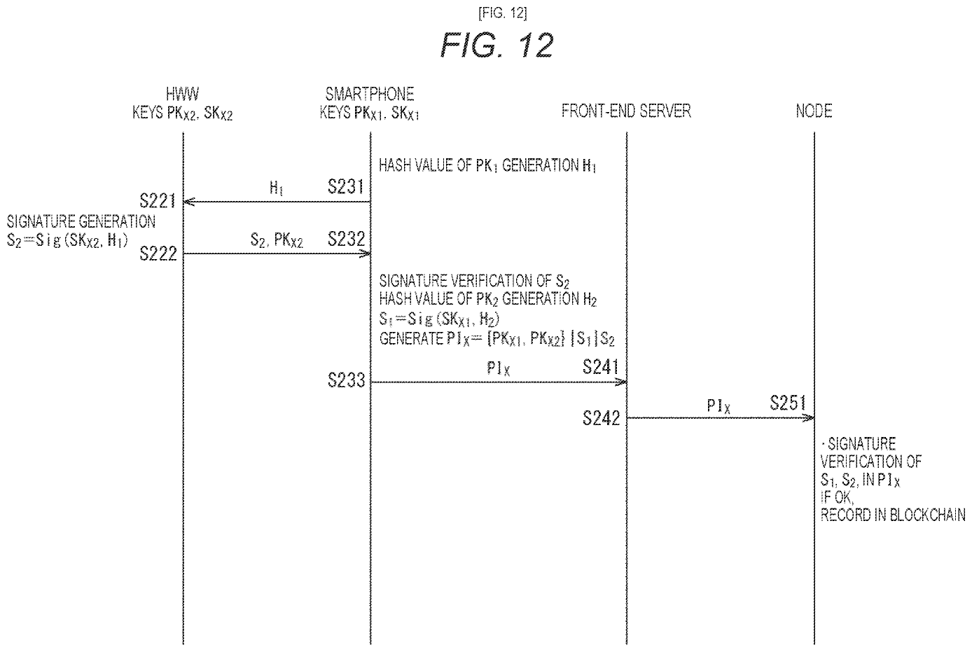

FIG. 12 is a data flow diagram illustrating a flow of data in the fourth processing.

The smartphone 31 generates the hash value H₁ of the public key PK_{X1} of the hot wallet for the service b, and transmits the hash value H₁ to the HWW 41 for the service a in step S231.

In step S221, the HWW 41 receives the hash value H₁ of the public key PK_{X1} of the hot wallet from the smartphone 31.

The HWW 41 generates a digital signature S2=Sig (SK_{X2}, H₁) of the public key PK_{X1} by performing signature generation processing on the hash value H₁ with the secret key SK_{X2} of the HWW 41.

In step S222, the HWW 41 transmits the digital signature S₂ and the public key PK_{X2} of the HWW 41 to the smartphone 31.

In step S232, the smartphone 31 receives the digital signature S₂ from the HWW 41 and the public key PK_{X2} of the HWW 41.

The smartphone 31 verifies the digital signature S₂ using the public key PK_{X2} of the HWW 41, and when the verification is successful, generates a hash value H₂ of the public key PK_{X2} of the HWW 41.

The smartphone 31 generates the digital signature S₁ of the public key PK_{X2} by performing signature generation processing on the hash value H₂ with the secret key SK_{X1} of the hot wallet.

The smartphone 31 generates association information {PK_{X1}, PK_{X2}} in which the public key PK_{X1} of the hot wallet and the public key PK_{X2} of the HWW 41 are associated with each other.

The smartphone 31 adds the digital signatures S₁ and S₂ to the association information {PK_{X1}, PK_{X2}} to generate the association certificate PI_{X}={PK_{X1}, PK_{X2}}|S₁|S2.

In step S233, the smartphone 31 transmits the association certificate PI_{X} to the front-end server 11 for the service b, and requests recording of the association information in the blockchain.

In step S241, the front-end server 11 receives the association certificate PI_{X} from the smartphone 31, and in step S242, transmits the association certificate PI_{X} to the node 21 to request recording of the association information in the blockchain.

In step S251, the node 21 receives the association certificate PI_{X} from the front-end server 11. The node 21 performs verification of the digital signatures S₁ and S₂ included in the association certificate PI_{X} or the like, and when the verification or the like is successful, records the association information {PK_{X1}, PK_{X2}} included in the association certificate PI_{X} in the blockchain for the service b.

Thereafter, in a case where the user X receives provision of the service b using the HWW 41 for the service a, processing similar to the case of the second processing and the third processing is performed.

That is, in the node 21, the transaction data is processed assuming that the owners of the public key PK_{X1} of the hot wallet and the public key PK_{X2} of the HWW 41 associated in the association information are the same user.

As a result, the user X can use the HWW 41 for the service a to receive the provision of the service b that has been received using the hot wallet for the service b. For example, information such as a contract recorded in a blockchain using a hot wallet may be accessed using the HWW 41. Therefore, user convenience can be improved.

Note that the user X can also receive the provision of the service b by using the hot wallet for the service b. Therefore, according to the fourth processing, it is possible to ensure the effectiveness of both the HWW 41 for the service a and the hot wallet for the service b for the service b.

Here, also in the fourth processing, similarly to the case of the second processing, the association information can be recorded in a means other than the blockchain, for example, can be recorded in a table as a recording area for the association information secured in the front-end server 11.

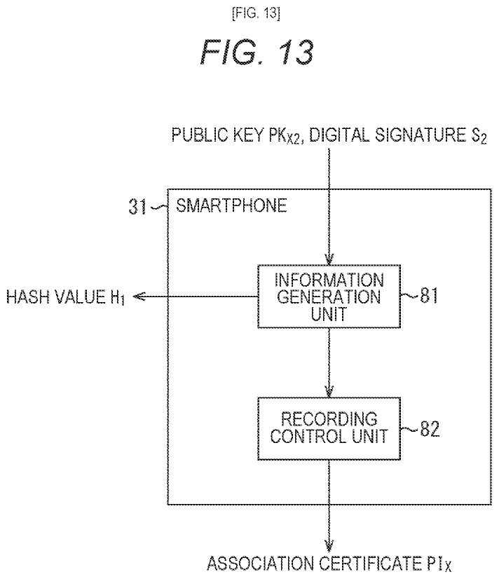

FIG. 13 is a block diagram illustrating a functional configuration example of the smartphone 31 that generates association information in which the public key PK_{X1} of the hot wallet and the public key PK_{X2} of the HWW 41 as a plurality of public keys are associated with each other and records the association information in the blockchain in the fourth processing.

The smartphone 31 includes an information generation unit 81 and a recording control unit 82.

The information generation unit 81 acquires a plurality of public keys to be associated in the association information.

For example, the information generation unit 81 reads and acquires the public key PK_{X1} of the hot wallet stored in the smartphone 31.

The information generation unit 81 generates a hash value H₁ of the public key PK_{X1} of the hot wallet and transmits the hash value H₁ to the HWW 41.

When the hash value H₁ of the public key PK_{X1} of the hot wallet is transmitted from the smartphone 31, the HWW 41 generates a digital signature S₂=Sig (SK_{X2}, H₁) of the public key PK_{X1} by performing signature generation processing on the hash value H₁ with the secret key SK_{X2} of the HWW 41.

Then, the HWW 41 transmits the digital signature S₂ of the public key PK_{X1} and the public key PK_{X2} of the HWW 41 to the smartphone 31.

The information generation unit 81 receives and acquires the public key PK_{X2} of the HWW 41 and the digital signature S₁ transmitted from the HWW 41 to the smartphone 31 as described above.

The information generation unit 81 verifies the digital signature S2 of the public key PK_{X1} using the public key PK_{X2} of the HWW 41, and when the verification is successful, generates a hash value H₂ of the public key PK_{X2} of the HWW 41.

Further, the information generation unit 81 generates the digital signature S₁ of the public key PK_{X2} by performing signature generation processing on the hash value H₂ of the public key PK_{X2} of the HWW 41 with the secret key SK_{X1} of the hot wallet.

Thereafter, the information generation unit 81 generates association information {PK_{X1}, PK_{X2}} in which the public key PK_{X1} of the hot wallet and the public key PK_{X2} of the HWW 41 are associated with each other.

Then, the information generation unit 81 adds the digital signature S₁ of the public key PK_{X2} and the digital signature S₂=Sig (SK_{X2}, H₁) of the public key PK_{X1} to the association information {PK_{X1}, PK_{X2}} to generate the association certificate PI_{X}={PK_{X1}, PK_{X2}}|S₁|S₂ and supplies the association certificate PI_{X}={PK_{X1}, PK_{X2}}|S₁|S₂ to the recording control unit 82.

The recording control unit 82 performs recording control to record the association information in the blockchain.

The recording control unit 82 transmits the association certificate PI_{X} from the information generation unit 81 to (the node 21 of) the blockchain system 12 via the front-end server 11, thereby recording the association information {PK_{X1}, PK_{X2}} included in the association certificate PI_{X} in the blockchain.

Note that, in the smartphone 31 in FIG. 13, association information {PK_{X1}, PK_{X2}} in which the public key PK_{X1} of the hot wallet for the service b and the public key PK_{X2} of the HWW 41 for the service a are associated with each other is generated and recorded in the blockchain.

However, in the smartphone 31 of FIG. 13, association information in which the public keys of a plurality of wallets for the same service are associated, for example, association information {PK_{X1}, PK_{X2}} in which the public key PK_{X1} of the hot wallet for the service a and the public key PK_{X2} of the HWW 41 for the service a are associated with each other can be generated and recorded in the blockchain.

Therefore, in the second processing and the third processing, the smartphone 31 having the functional configuration in FIG. 13 can generate association information {PK_{X1}, PK_{X2}} in which the public key PK_{X1} of the hot wallet and the public key PK_{X2} of the HWW 41 are associated with each other instead of the management server 16 and record the association information in the blockchain. Similarly, in a case where the front-end server 11 stores the hot wallet, the front-end server 11 has the functional configuration of FIG. 13 and can generate association information {PK_{X1}, PK_{X2}} in which the public key PK_{X1} of the hot wallet and the public key PK_{X2} of the HWW 41 are associated with each other and record the association information in the blockchain.

### <Fifth Processing of Information Processing System 10>

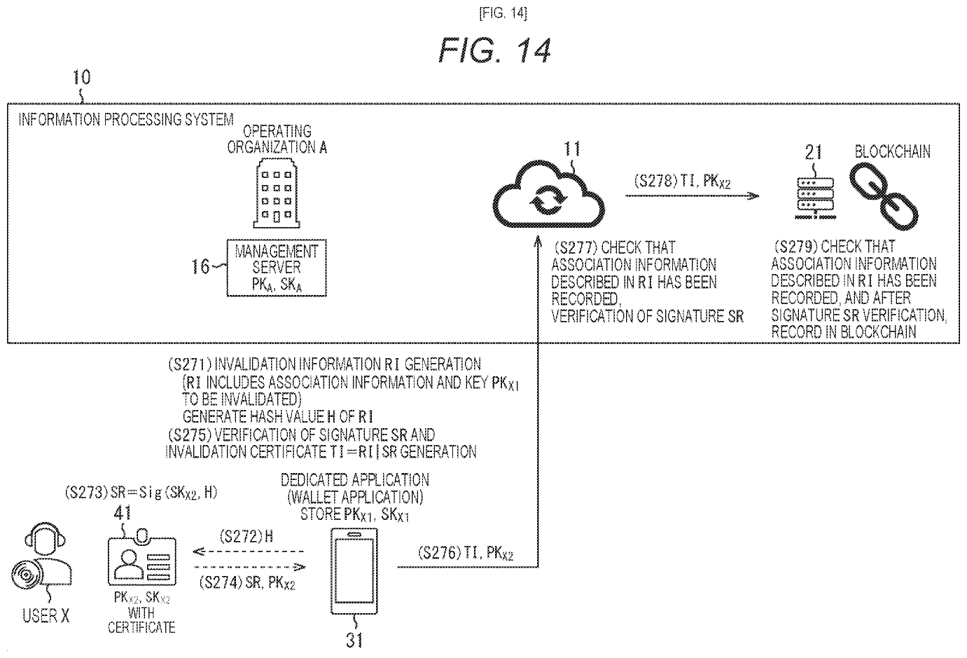

FIG. 14 is a diagram for explaining an example of fifth processing of the information processing system 10 in FIG. 1.

As described above, by recording the association information {PK_{X1}, PK_{X2}} in which the public key PK_{X1} of the hot wallet and the public key PK_{X2} of the HWW 41 are associated with each other in the blockchain, the user X can receive the provision of the service a using either the hot wallet or the HWW 41. Furthermore, in addition to the hot wallet for service b, the service b can be provided using the HWW 41 for service a.

By the way, after recording the association information in the blockchain, there may be a case where it is desired to invalidate any one of the wallets in which a plurality of public keys associated in the association information is kept.

For example, there may be a case where it is desired to invalidate the hot wallet (to disable the hot wallet) in preparation for loss, theft, or the like of the smartphone 31.

The fifth processing of the information processing system 10 in FIG. 14 is a process of invalidating the hot wallet as described above.

Note that, in the fifth processing, it is assumed that the user X is already a member of the service a. Then, it is assumed that the user X already owns the HWW 41 and the hot wallet for the service a.

In addition, in the fifth processing, it is assumed that a wallet application for receiving the provision of the service a is installed as a dedicated application in the smartphone 31. Then, it is assumed that the hot wallet is stored (managed) in the wallet application (smartphone 31).

In a case of invalidating the hot wallet, the user X activates the wallet application as a dedicated application installed in the smartphone 31. Then, the user X operates the smartphone 31 so as to invalidate the hot wallet.

In step S271, the smartphone 31 generates the invalidation information RI according to the operation of the user X.

The invalidation information RI is information indicating a public key (hereinafter, also referred to as invalidation target key) of a wallet to be invalidated, and includes, for example, an invalidation target key and association information including the invalidation target key.

In the fifth processing, since the hot wallet is invalidated, the invalidation information RI includes the public key PK_{X1} of the hot wallet as the invalidation target key and the association information {PK_{X1}, PK_{X2}} including the public key PK_{X1}.

The smartphone 31 generates the hash value H of the invalidation information RI and transmits the hash value H to the HWW 41 in step S272. Here, it is assumed that the smartphone 31 and the HWW 41 are in a communicable state.

The HWW 41 receives the hash value H of the invalidation information RI from the smartphone 31.

In step S273, the HWW 41 generates the digital signature SR=Sig (SK_{X2}, H) of the invalidation information RI by performing signature generation processing on the hash value H of the invalidation information RI with the secret key SK_{X2} of the HWW 41.

In step S274, the HWW 41 transmits the digital signature SR of the invalidation information RI and (the public key certificate of) the public key PK_{X2} of the HWW 41 to the smartphone 31.

The smartphone 31 receives the digital signature SR of the invalidation information RI from the HWW 41 and the public key PK_{X2} of the HWW 41.

In step S275, the smartphone 31 verifies the digital signature SR of the invalidation information RI using the public key PK_{X2} of the HWW 41. When the digital signature SR is successfully verified, the smartphone 31 adds the digital signature SR of the invalidation information RI to the invalidation information RI, thereby generating an invalidation certificate TI=RI|SR that certifies the authenticity of the invalidation information RI.

In step S276, the smartphone 31 transmits the invalidation certificate TI to the blockchain system 12, thereby performing recording control to record the invalidation information RI included in the invalidation certificate TI in the blockchain.

That is, the smartphone 31 transmits the invalidation certificate TI and the public key PK_{X2} of the HWW 41 to the front-end server 11, and requests recording of the invalidation information RI in the blockchain.

The front-end server 11 receives the invalidation certificate TI and the public key PK_{X2} of the HWW 41 from the smartphone 31.

In step S277, the front-end server 11 verifies the digital signature SR of the invalidation information RI included in the invalidation certificate TI. When the verification of the digital signature SR is successful, the front-end server 11 checks whether or not the association information {PK_{X1}, PK_{X2}} included in the invalidation information RI has been recorded in the blockchain via the node 21.

In a case where the association information {PK_{X1}, PK_{X2}} is recorded in the blockchain, in step S278, the front-end server 11 transmits the invalidation certificate TI and the public key PK_{X2} of the HWW 41 to the node 21, and requests the node 21 to record the invalidation information RI in the blockchain.

The node 21 receives the invalidation certificate TI and the public key PK_{X2} of the HWW 41 from the front-end server 11. In step S278, the node 21 verifies the digital signature SR of the invalidation information RI included in the invalidation certificate TI. When the verification of the digital signature SR is successful, the front-end server 11 checks whether or not the association information {PK_{X1}, PK_{X2}} included in the invalidation information RI has been recorded in the blockchain.

In a case where the association information {PK_{X1}, PK_{X2}} is recorded in the blockchain, the node 21 records the invalidation information RI in the blockchain.

In the node 21, in a case where the invalidation information indicating the verification public key used for verifying the digital signature of the transaction data is recorded in the blockchain, processing of the transaction data is restricted (processing of the transaction data is not performed).

The verification public key used for verifying the digital signature of the transaction data transmitted to the node 21 by using the hot wallet is the public key PK_{X1} of the hot wallet. Therefore, after the invalidation information RI including the public key PK_{X1} as the invalidation target key is recorded in the blockchain, processing of transaction data transmitted to the node 21 using the hot wallet is restricted. That is, the hot wallet is invalidated (disabled). Therefore, (the secret key SK_{X1} of) the hot wallet can be prevented from being misused.

Note that, here, both the front-end server 11 and the node 21 verify the digital signature SR of the invalidation information RI and confirm whether the association information {PK_{X1}, PK_{X2}} has been recorded in the blockchain. However, the verification of the digital signature SR of the invalidation information RI and the confirmation as to whether the association information {PK_{X1}, PK_{X2}} has been recorded in the blockchain may be performed by only one of the front-end server 11 and the node 21.

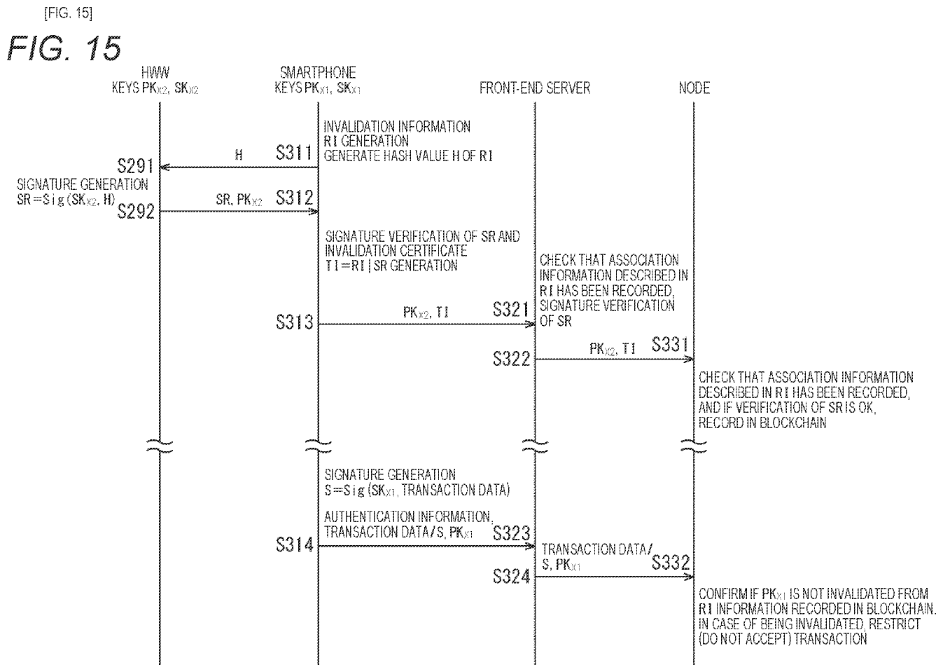

FIG. 15 is a data flow diagram illustrating a flow of data in the fifth processing.

The smartphone 31 generates invalidation information RI including a public key PK_{X1} of a hot wallet as an invalidation target key and association information {PK_{X1}, PK_{X2}} including the public key PK_{X1}. Further, the smartphone 31 generates the hash value H of the invalidation information RI.

In step S311, the smartphone 31 transmits the hash value H of the invalidation information RI to the HWW 41.

In step S291, the HWW 41 receives the hash value H of the invalidation information RI from the smartphone 31.

The HWW 41 generates a digital signature SR=Sig (SK_{X2}, H) of the invalidation information RI by performing signature generation processing on the hash value H of the invalidation information RI with the secret key SK_{X2} of the HWW 41.

In step S292, the HWW 41 transmits the digital signature SR of the invalidation information RI and the public key PK_{X2} of the HWW 41 to the smartphone 31.

In step S312, the smartphone 31 receives the digital signature SR of the invalidation information RI from the HWW 41 and the public key PK_{X2} of the HWW 41.

The smartphone 31 verifies the digital signature SR of the invalidation information RI using the public key PK_{X2} of the HWW 41, and when the verification is successful, adds the digital signature SR of the invalidation information RI to the invalidation information RI to generate an invalidation certificate TI=RI|SR.

The smartphone 31 transmits the invalidation certificate TI to the blockchain system 12, thereby performing recording control to record the invalidation information RI included in the invalidation certificate TI in the blockchain.

That is, in step S313, the smartphone 31 transmits the invalidation certificate TI and the public key PK_{X2} of the HWW 41 to the front-end server 11, and requests recording of the invalidation information RI in the blockchain.

In step S321, the front-end server 11 receives the invalidation certificate TI and the public key PK_{X2} of the HWW 41 from the smartphone 31.

The front-end server 11 verifies the digital signature SR of the invalidation information RI included in the invalidation certificate TI, and when the verification is successful, checks whether or not the association information {PK_{X1}, PK_{X2}} included in the invalidation information RI has been recorded in the blockchain via the node 21.

In a case where the association information {PK_{X1}, PK_{X2}} is recorded in the blockchain, in step S322, the front-end server 11 transmits the invalidation certificate TI and the public key PK_{X2} of the HWW 41 to the node 21, and requests the node 21 to record the invalidation information RI in the blockchain.

In step S331, the node 21 receives the invalidation certificate TI and the public key PK_{X2} of the HWW 41 from the front-end server 11.

The node 21 verifies the digital signature SR of the invalidation information RI included in the invalidation certificate TI, and when the verification is successful, checks whether or not the association information {PK_{X1}, PK_{X2}} included in the invalidation information RI has been recorded in the blockchain.

In a case where the association information {PK_{X1}, PK_{X2}} is recorded in the blockchain, the node 21 records the invalidation information RI in the blockchain. As a result, the public key PK_{X1} (included in the invalidation information RI as the invalidation target key) indicated by the invalidation information RI, and thus, the hot wallet keeping (the secret key SK_{X1} of) the public key PK_{X1} is invalidated.

After the invalidation information RI is recorded in the blockchain, it is assumed that the user X operates the smartphone 31 to use a hot wallet and further operates the smartphone 31 to input transaction information in order to receive the provision of the service a. The smartphone 31 generates transaction data corresponding to transaction information input according to the operation of the user X.

The smartphone 31 generates a digital signature S=Sig (SK_{X1}, (hash value of) transaction data) of the transaction data by using the secret key SK_{X1} of the hot wallet.

In step S314, the smartphone 31 transmits the authentication information, the transaction data with the digital signature S, and (the public key certificate of) the public key PK_{X1} of the hot wallet to the front-end server 11.

In step S323, the front-end server 11 receives the authentication information from the smartphone 31, the transaction data with the digital signature S, and the public key PK_{X1}.

The front-end server 11 authenticates the user X using the authentication information, and when the authentication is successful, transmits the transaction data with the digital signature S and the public key PK_{X1} to the node 21 in step S324.

In step S332, the node 21 receives the transaction data with the digital signature S and the public key PK_{X1} from the front-end server 11.

The node 21 checks whether or not invalidation information RI representing (including) the public key PK_{X1} used for verifying the digital signature S of the transaction data with the digital signature S from the front-end server 11 is recorded in the blockchain.

Then, in a case where the invalidation information RI indicating the public key PK_{X1} is recorded in the blockchain, the node 21 restricts the processing of the transaction data with the digital signature S from the front-end server 11 (does not process the transaction data).

Note that, in a case where the invalidation information RI indicating the public key PK_{X1} is not recorded in the blockchain, the node 21 processes the transaction data similarly to the case of the second processing and the third processing.

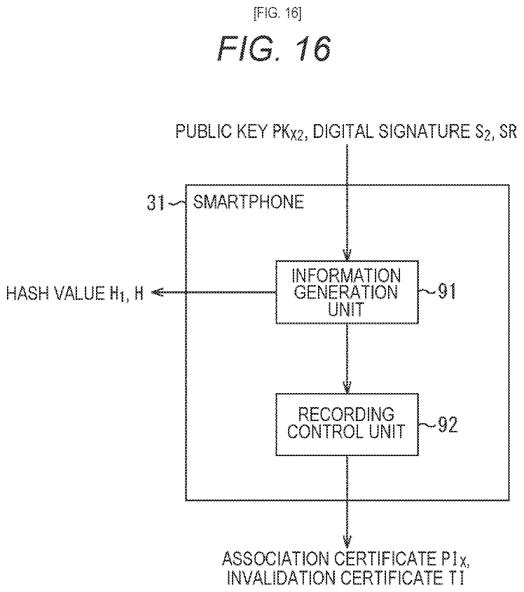

FIG. 16 is a block diagram illustrating a functional configuration example of the smartphone 31 that generates the invalidation information RI and records the invalidation information RI in the blockchain in the fifth processing.

The smartphone 31 includes an information generation unit 91 and a recording control unit 92.

The information generation unit 91 and the recording control unit 92 have functions similar to those of the information generation unit 81 and the recording control unit 82 in FIG. 13, respectively.

Therefore, according to the smartphone 31 including the information generation unit 91 and the recording control unit 92, association information {PK_{X1}, PK_{X2}} in which the public key PK_{X1} of the hot wallet and the public key PK_{X2} of the HWW 41 are associated with each other can be generated and recorded in the blockchain instead of the management server 16.

Furthermore, the information generation unit 91 and the recording control unit 92 have a function of generating the invalidation information RI and recording the invalidation information RI in the blockchain.

That is, the information generation unit 91 acquires a public key as an invalidation target key.

For example, the information generation unit 91 reads and acquires the public key PK_{X1} of the hot wallet stored in the smartphone 31 as the invalidation target key.

The information generation unit 91 generates invalidation information RI including the public key PK_{X1} as the invalidation target key and the public key PK_{X1} and including association information {PK_{X1}, PK_{X2}} recorded in the blockchain in the past.

The information generation unit 91 generates a hash value H of the invalidation information RI and transmits the hash value H to the HWW 41.

When the hash value H of the invalidation information RI is transmitted from the smartphone 31, the HWW 41 generates the digital signature SR=Sig (SK_{X2}, H) of the invalidation information RI by performing signature generation processing on the hash value H with the secret key SK_{X2} of the HWW 41.

Then, the HWW 41 transmits the digital signature SR of the invalidation information RI and the public key PK_{X2} of the HWW 41 to the smartphone 31.

The information generation unit 91 receives and acquires the digital signature SR of the invalidation information RI and the public key PK_{X2} of the HWW 41 transmitted from the HWW 41 to the smartphone 31 as described above.

The information generation unit 91 verifies the digital signature SR of the invalidation information RI using the public key PK_{X2} of the HWW 41, and when the verification is successful, adds the digital signature SR of the invalidation information RI to the invalidation information RI to generate an invalidation certificate TI=RI|SR.

The information generation unit 91 supplies the invalidation certificate TI and the public key PK_{X2} of the HWW 41 to the recording control unit 92.

The recording control unit 92 performs recording control to record the invalidation information RI in the blockchain.

The recording control unit 92 transmits the invalidation certificate TI from the information generation unit 91 and the public key PK_{X2} of the HWW 41 to (the node 21 of) the blockchain system 12 via the front-end server 11, thereby recording the invalidation information RI included in the invalidation certificate TI in the blockchain.

Note that, in the fifth processing, the smartphone 31 stores the hot wallet, but the hot wallet can be stored in the front-end server 11 instead of the smartphone 31.

In a case where the front-end server 11 stores a hot wallet, the front-end server 11 has a functional configuration similar to that of the smartphone 31 illustrated in FIG. 16, and can perform processing similar to that of the smartphone 31 in FIG. 16 by exchanging necessary information with the HWW 41 via the smartphone 31.

That is, instead of the management server 16, the front-end server 11 can generate association information {PK_{X1}, PK_{X2}} in which the public key PK_{X1} of the hot wallet and the public key PK_{X2} of the HWW 41 are associated with each other and record the association information in the blockchain. Further, the front-end server 11 may generate the invalidation information RI and record the invalidation information RI in the blockchain.

### <Sixth Processing of Information Processing System 10>

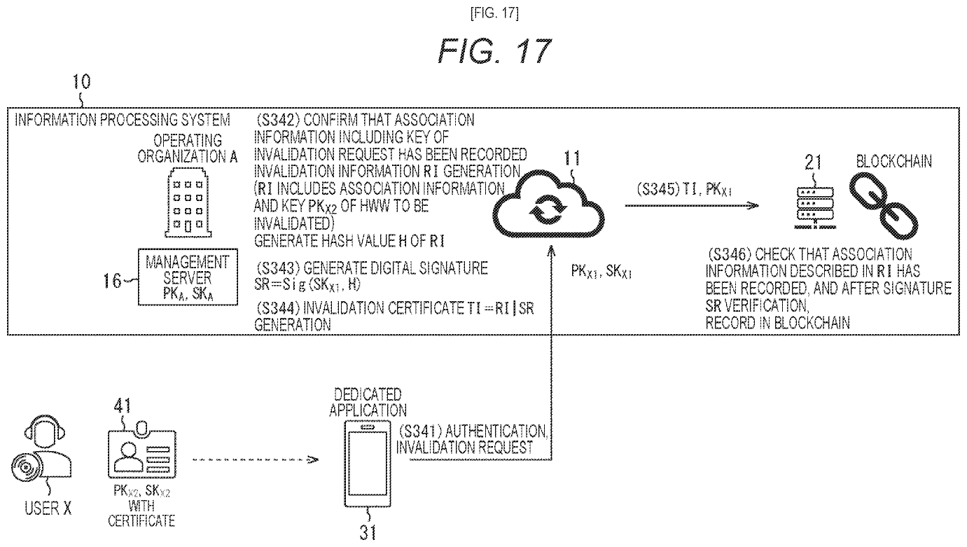

FIG. 17 is a diagram for explaining an example of sixth processing of the information processing system 10 in FIG. 1.

In the fifth processing, the hot wallet is invalidated, but there may be a case where it is desired to invalidate the HWW 41 in preparation for loss, theft, or the like of the HWW 41.

The sixth processing of the information processing system 10 of FIG. 17 is a process of invalidating the HWW 41.

Note that, in the sixth processing, it is assumed that the user X has already become a member of the service a. Then, it is assumed that the user X already owns the HWW 41 and the hot wallet for the service a.

In addition, in the sixth processing, it is assumed that a wallet application for receiving the provision of the service a is installed as a dedicated application in the smartphone 31.

Furthermore, in the sixth processing, it is assumed that a hot wallet is stored in the front-end server 11 (for the service a).

In a case of invalidating the HWW 41, the user X activates a wallet application as a dedicated application installed in the smartphone 31. Then, the user X logs in to the service a and operates the smartphone 31 so as to invalidate the HWW 41.

In step S341, the smartphone 31 logs in to the service a by transmitting the authentication information to the front-end server 11 according to the operation of the user X.

Further, the smartphone 31 transmits an invalidation request for requesting invalidation of the HWW 41 to the front-end server 11 according to the operation of the user X. The invalidation request includes the public key PK_{X2} of the HWW 41 as the invalidation target key.

The front-end server 11 receives an invalidation request from the smartphone 31. In step S342, the front-end server 11 checks whether or not the association information {PK_{X1}, PK_{X2}} including the public key PK_{X2} of the HWW 41 included in the invalidation request has been recorded in the blockchain via the node 21.

In a case where the association information {PK_{X1}, PK_{X2}} is recorded in the blockchain, the front-end server 11 generates invalidation information RI representing the public key PK_{X2} of the HWW 41 to be invalidated in response to the invalidation request.

Here, the invalidation information RI includes a public key PK_{X2} of the HWW 41 as an invalidation target key and association information {PK_{X1}, PK_{X2}} including the public key PK_{X1}.

After generating the invalidation information RI, the front-end server 11 generates the hash value H of the invalidation information RI.

Further, in step S343, the front-end server 11 generates a digital signature SR=Sig (SK_{X1}, H) of the invalidation information RI by performing signature generation processing on the hash value H of the invalidation information RI with the secret key SK_{X1} of the hot wallet.

In step S344, the front-end server 11 adds the digital signature SR of the invalidation information RI to the invalidation information RI, thereby generating an invalidation certificate TI=RI|SR that certifies the authenticity of the invalidation information RI.

In step S345, the front-end server 11 transmits the invalidation certificate TI to the blockchain system 12, thereby performing recording control to record the invalidation information RI included in the invalidation certificate TI in the blockchain.

That is, the front-end server 11 transmits the invalidation certificate TI and the public key PK_{X1} of the hot wallet to the node 21 and requests recording of the invalidation information RI in the blockchain.

The node 21 receives the invalidation certificate TI and the public key PK_{X1} of the hot wallet from the front-end server 11. In step S346, the node 21 verifies the digital signature SR of the invalidation information RI included in the invalidation certificate TI using the public key PK_{X1} of the hot wallet. When the verification of the digital signature SR is successful, the front-end server 11 checks whether or not the association information {PK_{X1}, PK_{X2}} included in the invalidation information RI has been recorded in the blockchain.

In a case where the association information {PK_{X1}, PK_{X2}} is recorded in the blockchain, the node 21 records the invalidation information RI in the blockchain.

In the node 21, similarly to the case of the fifth processing, in a case where invalidation information indicating a verification public key used for verifying the digital signature of the transaction data is recorded in the blockchain, the processing of the transaction data is restricted.

The verification public key used for verifying the digital signature of the transaction data transmitted to the node 21 by using the HWW 41 is the public key PK_{X2} of the HWW 41. Therefore, after the invalidation information RI including the public key PK_{X2} as the invalidation target key is recorded in the blockchain, processing of transaction data transmitted to the node 21 using the HWW 41 is restricted. That is, the HWW 41 is invalidated. Thus, (the secret key SK_{X2} of) the HWW 41 can be prevented from being misused.

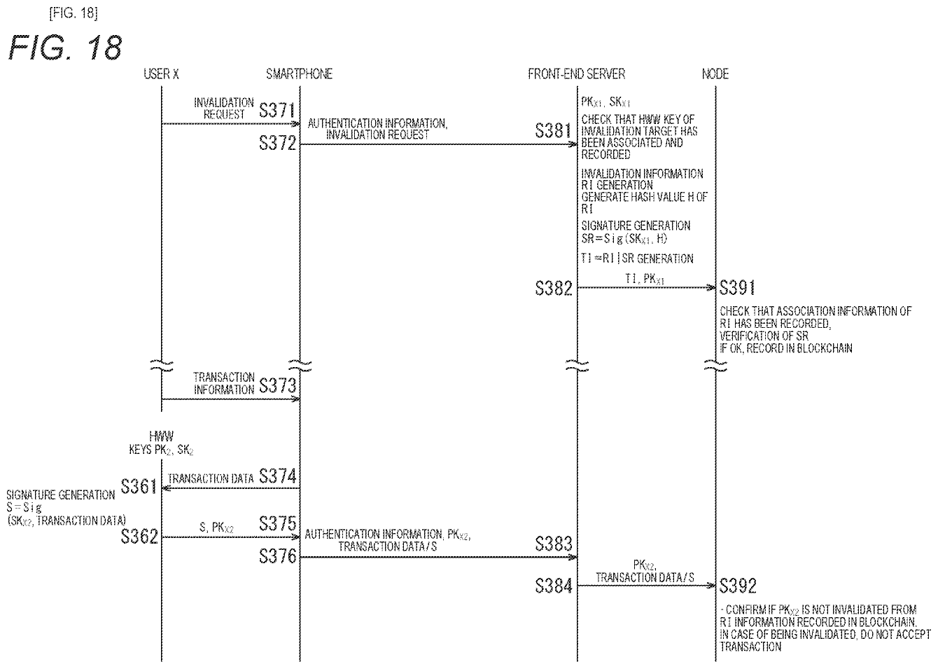

FIG. 18 is a data flow diagram illustrating a flow of data in the sixth processing.

When the user X operates the smartphone 31 so as to invalidate the HWW 41, the smartphone 31 receives the user's operation in step S371. Then, in step S372, in response to the operation of the user X, the smartphone 31 transmits, to the front-end server 11, an invalidation request including the authentication information and the public key PK_{X2} of the HWW 41 as the invalidation target key that requests invalidation of the HWW 41.

In step S381, the front-end server 11 receives the authentication information and the invalidation request from the smartphone 31.

The front-end server 11 authenticates the user X using the authentication information. When the authentication succeeds, the front-end server 11 checks, via the node 21, whether association information {PK_{X1}, PK_{X2}} including the public key PK_{X2} of the HWW 41 included in the invalidation request has been recorded in the blockchain.

In a case where the association information {PK_{X1}, PK_{X2}} is recorded in the blockchain, the front-end server 11 generates the invalidation information RI in response to the invalidation request. The invalidation information RI includes a public key PK_{X2} of the HWW 41 as an invalidation target key and association information {PK_{X1}, PK_{X2}} including the public key PK_{X1}.

The front-end server 11 generates a hash value H of the invalidation information RI, and generates a digital signature SR=Sig (SK_{X1}, H) of the invalidation information RI by performing signature generation processing on the hash value H with the secret key SK_{X1} of the hot wallet.

The front-end server 11 adds the digital signature SR of the invalidation information RI to the invalidation information RI to generate an invalidation certificate TI=RI|SR.

In step S382, the front-end server 11 transmits the invalidation certificate TI to the blockchain system 12, thereby performing recording control to record the invalidation information RI included in the invalidation certificate TI in the blockchain.

That is, the front-end server 11 transmits the invalidation certificate TI and the public key PK_{X1} of the hot wallet to the node 21 and requests recording of the invalidation information RI in the blockchain.

In step S391, the node 21 receives the invalidation certificate TI and the public key PK_{X1} of the hot wallet from the front-end server 11.

The node 21 verifies the digital signature SR of the invalidation information RI included in the invalidation certificate TI, and when the verification is successful, checks whether or not the association information {PK_{X1}, PK_{X2}} included in the invalidation information RI has been recorded in the blockchain.

In a case where the association information {PK_{X1}, PK_{X2}} is recorded in the blockchain, the node 21 records the invalidation information RI in the blockchain. As a result, the public key PK_{X2} (included in the invalidation information RI as the invalidation target key) indicated by the invalidation information RI, and thus the HWW 41 keeping (the secret key SK_{X2} for) the public key PK_{X2} is invalidated.

Thereafter, when the user X operates the smartphone 31 so as to use the HWW 41 and further operates the smartphone 31 so as to input transaction information, the smartphone 31 receives the transaction information according to the operation of the user in step S373.

The smartphone 31 generates transaction data corresponding to transaction information input according to the operation of the user X.

In step S374, the smartphone 31 transmits the hash value of the transaction data as signature target data to the HWW 41.

In step S361, the HWW 41 receives the hash value of the transaction data from the smartphone 31.

The HWW 41 generates a digital signature S=Sig (SK_{X2}, hash value of transaction data) of the transaction data by performing signature generation processing on the hash value of the transaction data from the smartphone 31 using the secret key SK_{X2} kept in the HWW 41.

In step S362, the HWW 41 transmits the digital signature S and the public key PK_{X2} kept in the HWW 41 to the smartphone 31.

In step S375, the smartphone 31 receives the digital signature S and the public key PK_{X2} from the HWW 41. The smartphone 31 generates transaction data with the digital signature S by adding the digital signature S to the transaction data.

In step S378, the smartphone 31 transmits the authentication information, the transaction data with the digital signature S, and the public key PK_{X2} to the front-end server 11.

In step S383, the front-end server 11 receives the authentication information from the smartphone 31, the transaction data with the digital signature S, and the public key PK_{X2}.

The front-end server 11 authenticates the user X using the authentication information, and when the authentication is successful, transmits the transaction data with the digital signature S and the public key PK_{X2} to the node 21 in step S384.

In step S392, the node 21 receives the transaction data with the digital signature S and the public key PK_{X2} from the front-end server 11.

The node 21 checks whether the public key PK_{X2} used for verifying the digital signature S of the transaction data with the digital signature S from the front-end server 11 is invalidated from the invalidation information RI recorded in the blockchain. That is, the node 21 checks whether or not invalidation information RI representing (including) the public key PK_{X2} used for verifying the digital signature S of the transaction data with the digital signature S from the front-end server 11 is recorded in the blockchain.

Then, in a case where the invalidation information RI indicating the public key PK_{X1} is recorded in the blockchain, the node 21 restricts the processing of the transaction data with the digital signature S from the front-end server 11.

Note that, in a case where the invalidation information RI indicating the public key PK_{X2} is not recorded in the blockchain, the node 21 processes the transaction data similarly to the case of the second processing and the third processing.

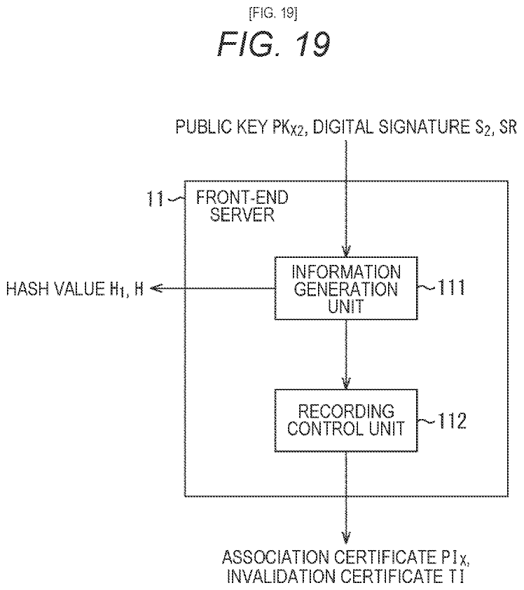

FIG. 19 is a block diagram illustrating a functional configuration example of the front-end server 11 that generates the invalidation information RI and records the invalidation information RI in the blockchain in the sixth processing.

In the front-end server 11 of FIG. 19, communication with the HWW 41 is performed via the smartphone 31.

The front-end server 11 includes an information generation unit 111 and a recording control unit 112.

The information generation unit 111 and the recording control unit 112 have functions similar to those of the information generation unit 81 and the recording control unit 82 in FIG. 13, respectively.

Therefore, according to the front-end server 11 including the information generation unit 111 and the recording control unit 112, association information {PK_{X1}, PK_{X2}} in which the public key PK_{X1} of the hot wallet and the public key PK_{X2} of the HWW 41 are associated with each other can be generated and recorded in the blockchain instead of the management server 16.

Furthermore, the information generation unit 111 and the recording control unit 112 have a function of generating the invalidation information RI and recording the invalidation information RI in the blockchain.

That is, the information generation unit 111 acquires a public key as an invalidation target key.

For example, the information generation unit 111 receives and acquires the public key PK_{X2} of the HWW 41 via the smartphone 31 as the invalidation target key.

The information generation unit 111 generates invalidation information RI including a public key PK_{X2} as an invalidation target key and association information {PK_{X1}, PK_{X2}} including the public key PK_{X2} and recorded in the blockchain in the past.

The information generation unit 111 generates a hash value H of the invalidation information RI, and generates a digital signature SR=Sig (SK_{X1}, H) of the invalidation information RI by performing signature generation processing on the hash value H with the secret key SK_{X1} of the hot wallet.

Then, the information generation unit 111 adds the digital signature SR of the invalidation information RI to the invalidation information RI to generate an invalidation certificate TI=RI|SR.

The information generation unit 111 supplies the invalidation certificate TI and the public key PK_{X1} of the hot wallet to the recording control unit 112.

The recording control unit 112 performs recording control to record the invalidation information RI in the blockchain.

The recording control unit 112 transmits the invalidation certificate TI from the information generation unit 111 and the public key PK_{X1} of the hot wallet to (the node 21 of) the blockchain system 12, thereby recording the invalidation information RI included in the invalidation certificate TI in the blockchain.

Note that, in the sixth processing, the front-end server 11 stores the hot wallet, but the hot wallet can be stored in the smartphone 31 instead of the front-end server 11.

In a case where the smartphone 31 stores a hot wallet, the smartphone 31 has a functional configuration similar to that of the front-end server 11 illustrated in FIG. 19, and exchanges necessary information with the HWW 41, so that processing similar to that of the front-end server 11 in FIG. 19 can be performed.

That is, instead of the management server 16, the smartphone 31 can generate association information {PK_{X1}, PK_{X2}} in which the public key PK_{X1} of the hot wallet and the public key PK_{X2} of the HWW 41 are associated with each other and record the association information in the blockchain. Furthermore, the smartphone 31 can generate the invalidation information RI and record the invalidation information RI in the blockchain.

### <Seventh Processing of Information Processing System 10>

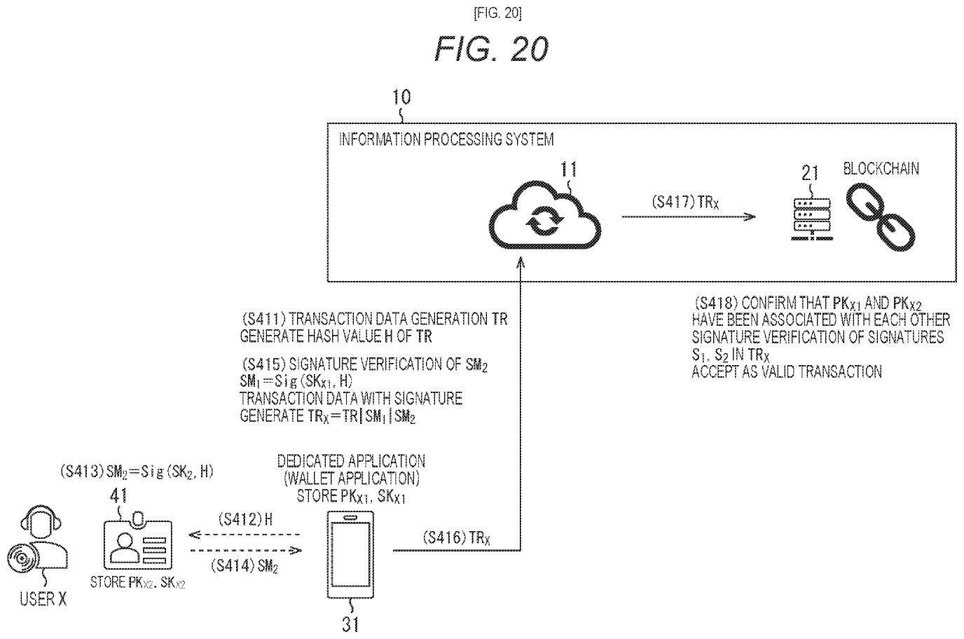

FIG. 20 is a diagram for explaining an example of seventh processing of the information processing system 10 in FIG. 1.

In the node 21, multi-signature can be adopted as a method of confirming the authenticity of the transaction data.

In the multi-signature, two or more digital signatures are added to the transaction data, and processing of the transaction data is performed in a case where verification of a number of digital signatures equal to or larger than a preset set number among the two or more digital signatures is successful.

On the other hand, in a case where the verification of the number of digital signatures equal to or larger than the set number is not successful, the processing of the transaction data is restricted.

In a case where the association information is recorded in the blockchain, in the multi-signature, for the transaction data, a predetermined number of digital signatures can be generated using each of secret keys for a predetermined number of two or more public keys among a plurality of public keys associated in the association information, and can be added to the transaction data.

Then, (the node 21 of) the blockchain system 12 can process the transaction data to which the predetermined number of digital signatures are added in a case where the verification of the number of digital signatures equal to or larger than the preset set number among the predetermined number of digital signatures added to the transaction data is successful. The set number is a number equal to or larger than two and equal to or smaller than a predetermined number.

For example, in a case where association information in which two public keys of the public key PK_{X1} of the hot wallet and the public key PK_{X2} of the HWW 41 are associated is recorded in the blockchain, two digital signatures as a predetermined number can be generated and added to the transaction data by using each of the secret keys SK_{X1} and SK_{X2} for the two public keys.

Then, in the blockchain system 12, in a case where the verification of the two digital signatures as the set number, that is, all the digital signatures added to the transaction data, of the two digital signatures as the predetermined number added to the transaction data, is successful, the transaction data can be processed.

The seventh processing of the information processing system 10 in FIG. 20 is a process in a case where the multi-signature as described above is applied.

Note that, in the seventh processing, it is assumed that the user X is already a member of the service a and already owns the HWW 41 and the hot wallet for the service a.

In addition, in the seventh processing, it is assumed that a wallet application for receiving the provision of the service a is installed as a dedicated application in the smartphone 31. Then, it is assumed that a hot wallet is stored in the wallet application (smartphone 31).

After the association information {PK_{X1}, PK_{X2}} in which the public key PK_{X1} of the hot wallet and the public key PK_{X2} of the HWW 41 are associated with each other is recorded in the blockchain, the user X operates the smartphone 31 so that the multi-signature is applied.

Further, the user X operates the smartphone 31 to input transaction information. In step S411, the smartphone 31 generates the transaction data TR corresponding to the transaction information input according to the operation of the user X, and generates the hash value H of the transaction data TR.

In step S412, the smartphone 31 transmits the hash value H of the transaction data TR to the HWW 41. Here, it is assumed that the smartphone 31 and the HWW 41 are in a communicable state.

The HWW 41 receives the hash value H of the transaction data TR from the smartphone 31.

In step S413, the HWW 41 generates a digital signature SM₂=Sig (SK_{X2}, H) of the transaction data TR by performing signature generation processing on the hash value H of the transaction data TR with the secret key SK_{X2} of the HWW 41.

In step S414, the HWW 41 transmits the digital signature SM₂ of the transaction data TR and the public key PK_{X2} of the HWW 41 to the smartphone 31.

The smartphone 31 receives the digital signature SM₂ of the transaction data TR from the HWW 41 and the public key PK_{X2} of the HWW 41.

In step S415, the smartphone 31 verifies the digital signature SM₂ of the transaction data TR using the public key PK_{X2} of the HWW 41. When the verification of the digital signature SM₂ is successful, the smartphone 31 generates the digital signature SM₁=Sig (SK_{X1}, H) of the transaction data TR by performing signature generation processing on the hash value H of the transaction data TR with the secret key SK_{X1} of the hot wallet.

Then, the smartphone 31 adds the digital signatures S₁ and SM₂ to the transaction data TR to generate two pieces of digitally signed transaction data TR_{X}=TR|SM₁|SM₂ as a predetermined number.

In step S416, the smartphone 31 transmits the two pieces of digitally signed transaction data TR_{X} to the front-end server 11.

The front-end server 11 receives two pieces of digitally signed transaction data TR_{X} from the smartphone 31.

In step S417, the front-end server 11 transmits the two pieces of digitally signed transaction data TR_{X} to the node 21 and requests recording of the transaction data in the blockchain.

The node 21 receives two pieces of digitally signed transaction data TR_{X} from the front-end server 11. In step S418, the node 21 determines whether association information {PK_{X1}, PK_{X2}} in which the public keys PK_{X1} and PK_{X2} used for verification of the digital signatures SM₁ and SM₂ of the two pieces of digitally signed transaction data TR_{X} are associated with each other is recorded in the blockchain.

In a case where the association information {PK_{X1}, PK_{X2}} is recorded in the blockchain, the node 21 verifies each of the digital signatures SM₁ and SM₂ of the two pieces of digitally signed transaction data TR_{X}.

In a case where verification of both the digital signatures SM₁ and SM₂ is successful, the node 21 receives the transaction data TR included in the digitally signed transaction data TR_{X} as valid transaction data. Then, the node 21 processes the transaction data TR assuming that the owners of the public keys PK_{X1} and PK_{X2} associated in the association information {PK_{X1}, PK_{X2}} are the same user.

Note that, in FIG. 20, the smartphone 31 stores the hot wallet, but the hot wallet may be stored not by the smartphone 31 but by the front-end server 11, for example, similarly to the case of the second processing and the third processing.

In a case where the front-end server 11 stores a hot wallet, the front-end server 11 communicates with the smartphone 31 to exchange necessary information with the HWW 41, and performs processing similar to that of the smartphone 31 in a case where a hot wallet is stored.

That is, the front-end server 11 performs the processing of steps S411, S412, and S415 instead of the smartphone 31.

In this case, it is desirable to prevent unauthorized access to the HWW 41 via the smartphone 31 by performing authentication between the front-end server 11 and the smartphone 31, or the like.

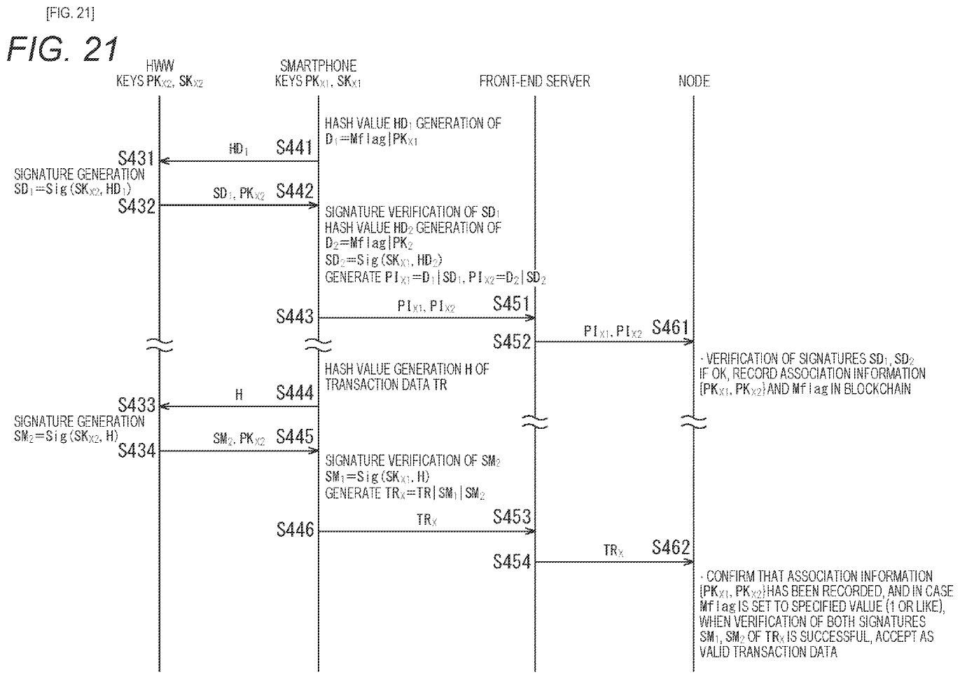

FIG. 21 is a data flow diagram illustrating a flow of data in the seventh processing.

In the seventh processing, similarly to the case of the second processing to the sixth processing, in addition to recording the association information {PK_{X1}, PK_{X2}} in the blockchain, the multi-signature information Mflag regarding the multi-signature can be recorded in the blockchain together with the association information {PK_{X1}, PK_{X2}}.

In a case where the multi-signature information Mflag is recorded in the blockchain together with the association information {PK_{X1}, PK_{X2}}, the smartphone 31 generates first information D₁=Mflag|PK_{X1} in which the multi-signature information Mflag is added to the public key PK_{X1} of the hot wallet. Further, the smartphone 31 generates a hash value HD₁ of the first information D₁.

Note that the multi-signature information Mflag is generated in the smartphone 31 according to a user's operation. The multi-signature information Mflag can indicate, for example, whether the multi-signature is applied. In a case where the multi-signature is applied, the multi-signature information Mflag is set to, for example, 1, and in a case where the multi-signature is not applied, the multi-signature information Mflag is set to, for example, 0.

The multi-signature information Mflag can include information regarding the multi-signature other than the information indicating whether the multi-signature is applied.

For example, the number (predetermined number) ND of digital signatures to be added to the transaction data and the number (set number) NS of digital signatures for which verification succeeds necessary for processing the transaction data among the digital signatures of the number ND can be set in advance, and these numbers ND and NS can be included in the multi-signature information Mflag.

Here, in order to simplify the description, it is assumed that 1 is set to the multi-signature information Mflag as a value indicating that the multi-signature is applied. In addition, it is assumed that two digital signatures are added to the transaction data, and the transaction data is processed in a case where the verification of the two digital signatures is successful.

In step S441, the smartphone 31 transmits the hash value HD₁ of the first information D₁ to the HWW 41.

In step S431, the HWW 41 receives the hash value HD₁ of the first information D₁ from the smartphone 31.

The HWW 41 generates a digital signature SD₁=Sig (SK_{X2}, HD₁) of the first information D₁ by performing signature generation processing on the hash value HD₁ of the first information D₁ with the secret key SK_{X2} of the HWW 41.

In step S432, the HWW 41 transmits the digital signature SD, of the first information D₁ and the public key PK_{X2} of the HWW 41 to the smartphone 31.

In step S442, the smartphone 31 receives the digital signature SD₁ of the first information D₁ from the HWW 41 and the public key PK_{X2} of the HWW 41.

The smartphone 31 verifies the digital signature SD₁ using the public key PK_{X2} of the HWW 41. When the verification is successful, the smartphone 31 generates second information D₂=Mflag|PK_{X2} in which the same multi-signature information Mflag as that added to the public key PK_{X1} of the hot wallet is added to the public key PK_{X2} of the HWW 41. Further, the smartphone 31 generates a hash value HD₂ of the second information D₂.

The smartphone 31 generates a digital signature SD₂=Sig (SK_{X2}, HD₂) of the second information D₂ by performing signature generation processing on the hash value HD₂ of the second information D₂ with the secret key SK_{X1} of the hot wallet.

Here, the public key PK_{X1} of the hot wallet included in the first information D₁ and the public key PK_{X2} of the HWW 41 included in the second information D₂ are indirectly associated with each other by the multi-signature information Mflag having the same value by adding the multi-signature information Mflag having the same value. Therefore, it can be said that the first information D₁ and the second information D₂ are association information in which the public key PK_{X1} of the hot wallet and the public key PK_{X2} of the HWW 41 are associated with each other.

The smartphone 31 generates the digitally signed first information PI_{X1} by adding the digital signature SD₁ to the first information D₁, and generates the digitally signed second information PI_{X2} by adding the digital signature SD₂ to the second information D₂.

In step S443, the smartphone 31 transmits the digitally signed first information PI_{X1} and the digitally signed second information PI_{X2} to the front-end server, and requests the front-end server 11 to record the association information and the multi-signature information Mflag in the blockchain.

In step S451, the front-end server 11 receives the digitally signed first information PI_{X1} and the digitally signed second information PI_{X2} from the smartphone 31.

In step S452, the front-end server 11 transmits the digitally signed first information PI_{X1} and the digitally signed second information PI_{X2} to the node 21, and requests the node 21 to record the association information and the multi-signature information Mflag in the blockchain.

In step S461, the node 21 receives the digitally signed first information PI_{X1} and the digitally signed second information PI_{X2} from the front-end server 11.

The node 21 verifies the digital signature SD, of the digitally signed first information PI_{X1} and the digital signature SD₂ of the digitally signed second information PI_{X2}.

When verification of both the digital signatures SD₁ and SD₂ is successful, the node 21 records the multi-signature information Mflag in the blockchain together with association information {PK_{X1}, PK_{X2}} in which the public key PK_{X1} of the hot wallet to which the multi-signature information Mflag is added in the first information D₁ included in the first information PI_{X1} is associated with the public key PK_{X2} of the HWW 41 to which the same multi-signature information Mflag as the public key PK_{X1} of the hot wallet is added in the second information D₂ included in the second information PI_{X2}.

Thereafter, in a case where the user X receives provision of the service a provided by the front-end server 11, the user X logs in to the service a.

The user X operates the smartphone 31 to use both the hot wallet and HWW 41 (to receive the application of the multi-signature), and further inputs transaction information by operating the smartphone 31.

The smartphone 31 generates the transaction data TR corresponding to the transaction information input according to the operation of the user X, and generates the hash value H of the transaction data TR.

In step S444, the smartphone 31 transmits the hash value H of the transaction data TR to the HWW 41.

In step S433, the HWW 41 receives the hash value H of the transaction data TR from the smartphone 31.

The HWW 41 generates a digital signature SM₂=Sig (SK_{X2}, H) of the transaction data TR by performing signature generation processing on the hash value H of the transaction data TR with the secret key SK_{X2} of the HWW 41.

In step S434, the HWW 41 transmits the digital signature SM₂=Sig (SK_{X2}, H) of the transaction data TR and (the public key certificate of) the public key PK_{X2} of the HWW 41 to the smartphone 31.

In step S445, the smartphone 31 receives the digital signature SM₂=Sig (SK_{X2}, H) of the transaction data TR from the HWW 41 and the public key PK_{X2} of the HWW 41.

The smartphone 31 verifies the digital signature SM₂ of the transaction data TR using the public key PK_{X2} of the HWW 41. When the verification of the digital signature SM₂ is successful, the smartphone 31 generates the digital signature SM₁=Sig (SK_{X1}, H) of the transaction data TR by performing signature generation processing on the hash value H of the transaction data TR with the secret key SK_{X1} of the hot wallet.

The smartphone 31 generates two pieces of digitally signed transaction data TR_{X}=TR|SM₁|SM₂ by adding the digital signatures SM₁ and SM₂ to the transaction data TR.

In step S446, the smartphone 31 records the transaction data in the blockchain by transmitting the digitally signed transaction data TR to the front-end server 11.

In step S453, the front-end server 11 receives the digitally signed transaction data TR_{X} from the smartphone 31.

In step S454, the front-end server 11 transmits the digitally signed transaction data TR_{X} to the node 21 and requests recording of the transaction data in the blockchain.

In step S462, the node 21 receives the digitally signed transaction data TR_{X} from the front-end server 11.

The node 21 determines (confirms) whether association information {PK_{X1}, PK_{X2}} in which the public keys PK_{X1} and PK_{X2} used for verification of the two digital signatures SM₁ and SM₂ of the digitally signed transaction data TR_{X} from the front-end server 11 are associated with each other is recorded in the blockchain.

In a case where the association information {PK_{X1}, PK_{X2}} is recorded in the blockchain, when the multi-signature information Mflag is recorded in the blockchain together with the association information {PK_{X1}, PK_{X2}}, the node 21 checks the multi-signature information Mflag.

In a case where the multi-signature information Mflag is set to 1 as a value indicating that the multi-signature is applied, the node 21 verifies each of the digital signatures SM₁ and SM₂ included in the digitally signed transaction data TR_{X}.

In a case where verification of both the digital signatures SM₁ and SM₂ is successful, the node 21 receives the transaction data TR included in the digitally signed transaction data TR_{X} as valid transaction data. Then, the node 21 processes the transaction data TR assuming that the owners of the public keys PK_{X1} and PK_{X2} associated in the association information {PK_{X1}, PK_{X2}} are the same user.

Note that, in a case where the verification of at least one of the digital signatures SM₁ and SM₂ fails, the transaction data TR is not received as valid transaction data, and the processing of the transaction data TR is restricted.

As described above, the transaction data TR is received as valid transaction data in a case where the digital signature SM₁ generated using the secret key SK_{X1} of the hot wallet and the digital signature SM₂ generated using the secret key SK_{X2} of the HWW 41 are verified successfully in the blockchain system 12 by applying the multi-signature. Therefore, even in a case where one of the smartphone 31 storing the hot wallet and the HWW 41 is stolen or the like, it is possible to prevent unauthorized transaction data from being processed even if the hot wallet or the HWW 41 is misused.

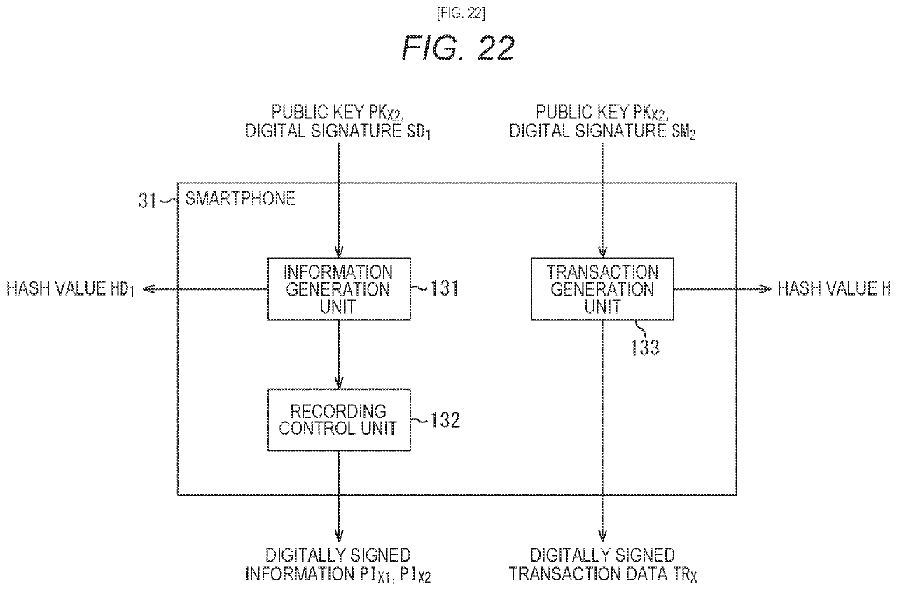

FIG. 22 is a block diagram illustrating a functional configuration example of the smartphone 31 that performs processing corresponding to the multi-signature in the seventh processing.

The smartphone 31 includes an information generation unit 131, a recording control unit 132, and a transaction generation unit 133.

The information generation unit 131 generates first information D₁=Mflag|PK_{X1} in which the multi-signature information Mflag is added to the public key PK_{X1} of the hot wallet, generates a hash value HD₁ of the first information D₁, and transmits the hash value HD₁ to the HWW 41.

The information generation unit 131 receives the digital signature SD₁=Sig (SK_{X2}, HD₁) of the first information D₁ obtained by performing signature generation processing on the hash value HD₁ of the first information D₁ with the secret key SK_{X2} of the HWW 41 and the public key PK_{X2} of the HWW 41 transmitted from the HWW 41 in response to the transmission of the hash value HD₁ of the first information D₁ to the HWW 41.

The information generation unit 131 generates second information D₂=Mflag|PK_{X2} in which the same multi-signature information Mflag as that added to the public key PK_{X1} of the hot wallet is added to the public key PK_{X2} of the HWW 41, and generates a hash value HD₂ of the second information D₂.

The information generation unit 131 generates a digital signature SD₂=Sig (SK_{X1}, HD₂) of the second information D₂ by performing signature generation processing on the hash value HD₂ of the second information D₂ with the secret key SK_{X1} of the hot wallet.

The information generation unit 131 adds the digital signature SD, to the first information D₁ to generate the digitally signed first information PI_{X1}, and adds the digital signature SD₂ to the second information D₂ to generate the digitally signed second information PI_{X2}.

Then, the information generation unit 131 supplies the digitally signed first information PI_{X1} and the digitally signed second information PI_{X2} to the recording control unit 132.

The recording control unit 132 performs recording control to record the association information and the multi-signature information Mflag in the blockchain.

The recording control unit 132 transmits the digitally signed first information PI_{X1} and the digitally signed second information PI_{X2} from the information generation unit 131 to (the node 21 of) the blockchain system 12 via the front-end server 11, thereby recording the multi-signature information Mflag and the association information {PK_{X1}, PK_{X2}} in which the public keys PK_{X1} and PK_{X2} are associated with each other by the same multi-signature information Mflag in the blockchain.

The transaction generation unit 133 generates a predetermined number of digitally signed transaction data generated using each secret key for a predetermined number of two or more public keys among a plurality of public keys associated in the association information, and transmits the transaction data to the blockchain system 12.

The transaction generation unit 133 generates the hash value H of the transaction data TR corresponding to the transaction information input according to the operation of the user X and transmits the hash value H to the HWW 41.

The transaction generation unit 133 receives the digital signature SM₂=Sig (SK_{X2}, H) of the transaction data TR and the public key PK_{X2} of the HWW 41 transmitted from the HWW 41 in response to the transmission of the hash value H of the transaction data TR to the HWW 41.

The transaction generation unit 133 generates a digital signature SM₁=Sig (SK_{X1}, H) of the transaction data TR by performing signature generation processing on the hash value H of the transaction data TR with the secret key SK_{X1} of the hot wallet.

The transaction generation unit 133 adds the digital signatures SM₁ and SM₂ to the transaction data TR to generate two pieces of digitally signed transaction data TR_{X}=TR|SM₁|SM₂.

The transaction generation unit 133 records the transaction data TR in the blockchain by transmitting the digitally signed transaction data TR_{X} to the front-end server 11.

Note that, in a case where the multi-signature is applied, the method described in the second processing to the sixth processing can be adopted as a method of recording the association information {PK_{X1}, PK_{X2}} in the blockchain. Then, the transaction generation unit 133 is provided in the front-end server 11 or the smartphone 31 that performs the second processing to the sixth processing, and it is possible to generate two pieces of digitally signed transaction data TR_{X}.

Furthermore, in the second processing and the third processing, the smartphone 31 having the functional configuration in FIG. 22 can record association information {PK_{X1}, PK_{X2}} in which the public key PK_{X1} of the hot wallet and the public key PK_{X2} of the HWW 41 are associated with each other in the blockchain instead of the management server 16.

Furthermore, in the seventh processing, the smartphone 31 stores the hot wallet, but the hot wallet can be stored in the front-end server 11 instead of the smartphone 31.

In a case where the front-end server 11 stores a hot wallet, the front-end server 11 has a functional configuration similar to that of the smartphone 31 illustrated in FIG. 22, and can perform processing similar to that of the smartphone 31 in FIG. 22 by exchanging necessary information with the HWW 41 via the smartphone 31.

That is, instead of the management server 16, the front-end server 11 can record association information {PK_{X1}, PK_{X2}} in which the public key PK_{X1} of the hot wallet and the public key PK_{X2} of the HWW 41 are associated with each other in the blockchain. In addition, the front-end server 11 can generate two pieces of digitally signed transaction data TR_{X}=TR|SM₁|SM₂ of the digital signatures SM₁ and SM₂.

Here, in the present specification, the processing performed by the computer such as the front-end server 11, the management server 16, the node 21, or the smartphone 31 according to the program is not necessarily performed in time series in the order described as the data flow. In other words, the process to be performed by the computer in accordance with the program includes processes to be executed in parallel or independently (for example, a parallel process or an object-based process).

Furthermore, the program may be processed by one computer (one processor) or processed in a distributed manner by a plurality of computers. Moreover, the program may be transferred to a distant computer to be executed.

Moreover, in the present specification, a system means a set of a plurality of components (devices, modules (parts), and the like), and it does not matter whether or not all the components are in the same housing. Therefore, a plurality of devices housed in separate housings and connected via a network and one device in which a plurality of modules is housed in one housing are both systems.

Note that the embodiments of the present technology are not limited to the above-described embodiments, and various changes can be made without departing from the gist of the present technology.

For example, the present technology may be configured as cloud computing in which one function is shared by a plurality of devices over the network to process together.

Furthermore, each step of the processing can be executed by one device or can be shared and executed by a plurality of devices.

Moreover, in a case where a plurality of processes is included in one step, the plurality of processes included in one step can be executed by one device or by a plurality of devices in a shared manner.

Furthermore, the effects described herein are merely examples and are not limited, and other effects may be provided.

Note that the present technology can have the following configurations.

<1>

An information processing apparatus including:
an information generation unit that generates association information in which a plurality of public keys is associated; and
a recording control unit that records the association information in a blockchain.
   <2>

The information processing apparatus according to <1>,
in which a first public key of the plurality of public keys is a public key for a secret key of a first wallet, and
a second public key of the plurality of public keys is a public key for a secret key of a second wallet.
   <3>

The information processing apparatus according to <2>,
in which the first wallet is a hot wallet, and
the second wallet is a cold wallet.
   <4>

The information processing apparatus according to
<3>,
in which the cold wallet is an HWW.
   <5>

The information processing apparatus according to <4>,
in which the information generation unit generates the association information in which a public key for a secret key of the hot wallet generated according to an application from a user is associated with a public key for a secret key of the HWW provided to the user according to an application from the user.
   <6>

The information processing apparatus according to <4>,
in which the information generation unit generates the association information in which a public key for a secret key of the hot wallet possessed by a user is associated with a public key for a secret key of the HWW provided to the user according to an application from the user.
   <7>

The information processing apparatus according to <4>,
in which the information generation unit generates the association information in which a public key for a secret key of the hot wallet possessed by a user is associated with a public key for a secret key of the HWW possessed by the user.
   <8>

The information processing apparatus according to any one of <1> to <7>,
in which the recording control unit transmits an association certificate certifying authenticity of the association information to a blockchain system to record the association information in the blockchain.
   <9>

The information processing apparatus according to <8>,
in which the association certificate includes a digital signature of the association information.
   <10>

The information processing apparatus according to <8>,
in which the association certificate includes,
among a first public key and a second public key associated in the association information:
a first digital signature obtained by performing signature generation processing on the second public key with a first secret key for the first public key; and
a second digital signature obtained by performing signature generation processing on the first public key with a second secret key for the second public key.
   <11>

The information processing apparatus according to any one of <1> to <10>,
in which, in a blockchain system, an owner of a plurality of public keys associated in the association information including a verification public key used to verify a digital signature of transaction data is regarded as a same user, and the transaction data is processed.
   <12>

The information processing apparatus according to any one of <1> to <11>,
in which the information generation unit generates invalidation information indicating a public key to be invalidated among a plurality of public keys associated in the association information, and
the recording control unit records the invalidation information in the blockchain.
   <13>

The information processing apparatus according to <12>,
in which, in a blockchain system, in a case where the association information including a public key indicated by the invalidation information is recorded in a blockchain, the invalidation information is recorded in the blockchain.
   <14>

The information processing apparatus according to <12> or <13>,
in which, in a blockchain system, in a case where the invalidation information indicating a verification public key used to verify a digital signature of transaction data is recorded in the blockchain, processing of the transaction data is restricted.
   <15>

The information processing apparatus according to any one of <1> to <14>, further including
a transaction generation unit that generates a predetermined number of digitally signed transaction data generated using each of secret keys for the predetermined number of two or more public keys among a plurality of public keys associated in the association information and transmits the transaction data to a blockchain system.
   <16>

The information processing apparatus according to <15>,
in which, in a blockchain system, in a case where verification of a number of digital signatures equal to or more than a preset set number among the predetermined number of digital signatures succeeds, transaction data to which the predetermined number of digital signatures are added is processed.
   <17>

An information processing method including:
generating association information in which a plurality of public keys is associated; and
recording the association information in a blockchain.
   <18>

A program for causing a computer to function as:
an information generation unit that generates association information in which a plurality of public keys is associated; and a recording control unit that records the association information in a blockchain.

### REFERENCE SIGNS LIST

10 Information processing system
11 Front-end server
12 Blockchain system
16 Management server
21 Node
31 Smartphone
32 PC
41 HWW
61 Information generation unit
62 Recording control unit
81 Information generation unit
82 Recording control unit
91 Information generation unit
92 Recording control unit
111 Information generation unit
112 Recording control unit
131 Information generation unit
132 Recording control unit
133 Transaction generation unit
901 Bus
902 CPU
903 ROM
904 RAM
905 Hard disk
906 Output unit
907 Input unit
908 Communication unit
909 Drive
910 Input/output interface
911 Removable recording medium

1. An information processing apparatus comprising:
an information generation unit that generates association information in which a plurality of public keys is associated; and
a recording control unit that records the association information in a blockchain.

2. The information processing apparatus according to claim 1,
wherein a first public key of the plurality of public keys is a public key for a secret key of a first wallet, and
a second public key of the plurality of public keys is a public key for a secret key of a second wallet.

3. The information processing apparatus according to claim 2,
wherein the first wallet is a hot wallet, and
the second wallet is a cold wallet.

4. The information processing apparatus according to claim 3,
wherein the cold wallet is an HWW.

5. The information processing apparatus according to claim 4,
wherein the information generation unit generates the association information in which a public key for a secret key of the hot wallet generated according to an application from a user is associated with a public key for a secret key of the HWW provided to the user according to an application from the user.

6. The information processing apparatus according to claim 4,
wherein the information generation unit generates the association information in which a public key for a secret key of the hot wallet possessed by a user is associated with a public key for a secret key of the HWW provided to the user according to an application from the user.

7. The information processing apparatus according to claim 4,
wherein the information generation unit generates the association information in which a public key for a secret key of the hot wallet possessed by a user is associated with a public key for a secret key of the HWW possessed by the user.

8. The information processing apparatus according to claim 1,
wherein the recording control unit transmits an association certificate certifying authenticity of the association information to a blockchain system to record the association information in the blockchain.

9. The information processing apparatus according to claim 8,
wherein the association certificate includes a digital signature of the association information.

10. The information processing apparatus according to claim 8,
wherein the association certificate includes,
among a first public key and a second public key associated in the association information:
a first digital signature obtained by performing signature generation processing on the second public key with a first secret key for the first public key; and
a second digital signature obtained by performing signature generation processing on the first public key with a second secret key for the second public key.

11. The information processing apparatus according to claim 1,
wherein, in a blockchain system, an owner of a plurality of public keys associated in the association information including a verification public key used to verify a digital signature of transaction data is regarded as a same user, and the transaction data is processed.

12. The information processing apparatus according to claim 1,
wherein the information generation unit generates invalidation information indicating a public key to be invalidated among a plurality of public keys associated in the association information, and
the recording control unit records the invalidation information in the blockchain.

13. The information processing apparatus according to claim 12,
wherein, in a blockchain system, in a case where the association information including a public key indicated by the invalidation information is recorded in a blockchain, the invalidation information is recorded in the blockchain.

14. The information processing apparatus according to claim 12,
wherein, in a blockchain system, in a case where the invalidation information indicating a verification public key used to verify a digital signature of transaction data is recorded in the blockchain, processing of the transaction data is restricted.

15. The information processing apparatus according to claim 1, further comprising
a transaction generation unit that generates a predetermined number of digitally signed transaction data generated using each of secret keys for the predetermined number of two or more public keys among a plurality of public keys associated in the association information and transmits the transaction data to a blockchain system.

16. The information processing apparatus according to claim 15,
wherein, in a blockchain system, in a case where verification of a number of digital signatures equal to or more than a preset set number among the predetermined number of digital signatures succeeds, transaction data to which the predetermined number of digital signatures are added is processed.

17. An information processing method comprising:
generating association information in which a plurality of public keys is associated; and
recording the association information in a blockchain.

18. A program for causing a computer to function as:
an information generation unit that generates association information in which a plurality of public keys is associated; and
a recording control unit that records the association information in a blockchain.
